(19) United States
(12) Patent Application Publication
(10) Pub. No.: US 2026/0342160 A1
(43) Pub. Date: Oct. 29, 2026

(54) PUMP COMPRISING AN ELECTRIC DRIVE MOTOR AND STATOR COOLING SYSTEM

(71) Applicant: Schwäbische Hüttenwerke Automotive GmbH, Aalen (DE)

(72) Inventors: Uwe Meinig, Bad Saulgau (DE); Dominik Baur, Scheer (DE)

(73) Assignee: Schwäbische Hüttenwerke Automotive GmbH, Aalen (DE)

(21) Appl. No.: 19/407,238

(22) Filed: Dec. 3, 2025

(30) Foreign Application Priority Data
Dec. 4, 2024 (DE) 10 2024 136 139.5

(51) Int. Cl. H02K 3/24; F01M 1/02; F01P 3/20; F01P 5/10; F04D 29/42; F04D 29/58; H02K 1/14; H02K 3/32; H02K 9/19; H02K 15/122; H02K 21/16

(52) U.S. Cl. CPC H02K 3/24; F01M 1/02; F01P 3/20; F01P 5/10; F04D 29/4293; F04D 29/5806; H02K 1/146; H02K 3/325; H02K 9/19; H02K 15/122; H02K 21/16

(57) ABSTRACT

A pump for delivering a fluid includes an inlet and an outlet for the fluid, an impeller, and an electric drive motor including a rotor, which is coupled to the impeller in order to drive it, and a stator which together with the rotor forms a clearance around a motor axis. The stator includes a stator core featuring stator teeth and tooth gaps which remain between the stator teeth, electrical lines which are wound around the stator teeth, to form electrical coils, a primary insulation between the respective stator tooth and the coil to electrically insulate the coil, and a secondary insulation which is formed in the tooth gaps in order to electrically insulate adjacent coils.

### CROSS-REFERENCE TO RELATED APPLICATIONS

This application claims priority to German Application No. 10 2024 136 139.5, filed Dec. 4, 2024, the contents of such application being incorporated by reference herein.

### FIELD OF THE INVENTION

The invention relates to a pump which is driven by an electric drive motor in order to deliver a fluid, preferably a liquid. The fluid to be delivered can for example be a cooling fluid and/or a lubricating fluid for cooling and/or lubricating one or more components of a traction drive of a motor vehicle. The pump can in particular be a coolant and/or lubricant pump for a motor vehicle and can for example serve to cool a primary battery and/or to cool and/or lubricate an electric traction motor of an all-electric vehicle or a hybrid vehicle or to cool and/or lubricate an internal combustion engine of a hybrid vehicle or a combustion-only vehicle.

### BACKGROUND OF THE INVENTION

Electrically driven pumps, predominantly formed as centrifugal pumps, are increasingly being used to deliver cooling media in motor vehicles. Currently, the electric drive motors used for this purpose are predominantly electronically commutated, i.e. brushless direct current (BLDC) motors which are generally operated at 12, 25 or 48 V. These integrated and/or pump-specific electric motors can be embodied either as so-called wet rotors or as dry rotors. In dry rotor pumps, the electric motor is generally mounted on roll bearings, wherein the part of the pump to which the fluid is applied is sealed off from the electric motor by a shaft gasket, for example a sliding ring gasket or a shaft sealing ring (lip seal). Dry rotor pumps are not widespread in cooling fluid pumps for passenger cars due to their large and expensive roll bearings, the significant cost of the technically demanding shaft gasket, the comparatively complex cooling designs for the electric motor, and the actuating printed circuit board assembly which is integrated into the pump, for example into a motor housing of the pump. In wet rotor pumps, at least parts of the electric motor, such as for example the rotor and the rotor bearings, are wetted by the delivered medium.

DE 10 2021 133 484 A1, incorporated herein by reference, discloses a fluid pump comprising an integrated electric drive motor through which the fluid to be delivered can flow for the purpose of cooling. The drive motor comprises a stator featuring a stator core around which electrical lines are wound in order to form electrical coils. A primary insulation is injection-moulded around the stator core before the electrical lines are wound around it, and a secondary insulation is additionally injection-moulded around it after the electrical lines have been wound around it and contacted, such that the injection-moulded insulation forms a can. The injection-moulded insulation comprises axially parallel groove-shaped cooling channels on the outer circumference and/or inner circumference of the stator and cavities which are formed between the cooling channels in the circumferential direction and correspond to the cooling channels in such a way that the fluid can circulate around the stator laminations which are exposed within the cavities.

### SUMMARY OF THE INVENTION

An aspect of the invention is a compact and cost-effective pump comprising an electric drive motor exhibiting a high overall efficiency and an effective cooling system.

The pump shall advantageously be suitable for use in a motor vehicle for delivering a cooling and/or lubricating fluid in said motor vehicle.

What is desirable is an electric drive motor for a pump which is compactly built, has a high overall efficiency and can be effectively cooled by means of fluid.

One aspect of the invention can also be regarded as being that of providing a compact and high-performance but inexpensive pump driven by an electric motor.

An aspect of the invention relates to a pump for delivering a fluid, for example a cooling and/or lubricating fluid. The fluid can be a gas or in particular a liquid. The pump comprises a delivery housing featuring an inlet and an outlet for the fluid, an impeller which can be rotated about a rotational axis in the delivery housing for delivering the fluid, and an electric drive motor for the impeller. The drive motor comprises a stator and a rotor which can be rotated about a motor axis relative to the stator and the delivery housing and which is coupled to the impeller in order to rotationally drive the impeller. The stator surrounds the rotor and, together with the rotor, forms a clearance which extends around the motor axis. The stator comprises a stator core featuring stator teeth, which at least substantially point radially with respect to the motor axis, and electrical coils which are wound onto the stator teeth. In order to electrically separate the coils from the stator core, the stator comprises a primary insulation which surrounds the respective stator tooth over its circumference and is formed between the respective stator tooth and the coil which surrounds said stator tooth. Another component of the stator is a secondary insulation which is formed in the tooth gaps between respectively adjacent stator teeth in order to electrically insulate adjacent coils.

The stator core can advantageously be a laminated core comprising stator laminations which are stacked axially one on top of the other. Embodying the stator core as a laminated core facilitates varying the axial length of the stator core by varying the number of stator laminations which lie one on top of the other, thus enabling the torque which can be produced by the drive motor to be varied in accordance with the application. The drive motor can thus be easily and flexibly adapted to the torque requirements of the application without changing its basic design.

In accordance with a first aspect of the invention, the ends of the stator teeth which radially face directly opposite the rotor across the clearance do not comprise the primary insulation or the secondary insulation. The ends of the stator teeth radially opposite the rotor can be coated with a thin layer of varnish. Preferably, however, they do not comprise any applied material in the region of the tooth ends, at least on the circumferential surface which radially faces the rotor. Since the ends of the respective stator teeth are not covered by either the insulating material of the primary insulation or the insulating material of the secondary insulation on their circumferential surface which radially faces the rotor, and which is also referred to below as the running surface, a clearance having a small radial clearance width can be realised. The smaller the radial clearance width, the lower the losses in magnetic flux density across the clearance, such that the coils can be reduced in size, with a corresponding reduction in the material used for the coil windings, while maintaining the same output. It is thus possible to realise a capable, energy-efficient but also compact and cost-effective and correspondingly competitive drive motor.

Since the respective stator teeth do not comprise the insulating material of the primary and secondary insulation on the circumferential running surface which radially faces the rotor and delineates the clearance, a cooling fluid can flow directly onto them in the clearance when it flows through the clearance. The cooling effect is further intensified if the metal of the stator tooth is exposed on the running surface of the respective stator tooth which radially faces the rotor. If the stator core is embodied as a laminated core, cooling fluid from the clearance can also pass between the stator laminations and advantageously cool the stator core from the inside.

In advantageous embodiments, the clearance between the rotor and the stator exhibits a radial clearance width, as measured radially with respect to the rotational axis, which is smaller than an average thickness of the primary insulation. If the primary insulation covers the stator core in the manner of a skin, as is preferred, the radial clearance width in such embodiments is smaller than the thickness of this “skin”. It is advantageous for the clearance to be able to exhibit a radial clearance width which merely compensates for the component tolerances and position tolerances as well as the bearing clearances of the drive motor, in order to prevent the running surface of the respective stator tooth from coming into contact with the opposing running surface of the rotor when the pump is in operation.

In order to be able to effectively cool the drive motor in view of the high power density which can be achieved by reducing the gap width, a second aspect of the invention is that in each of one or more of the tooth gaps, a cooling channel through which cooling fluid can flow extends in the axial direction through the secondary insulation. Expediently, a cooling channel through which cooling fluid can flow extends in the axial direction through the secondary insulation in each of the tooth gaps. In one or more of the tooth gaps, two or more cooling channels, through each of which cooling fluid can flow, can extend in the axial direction through the secondary insulation. Preferably, however, only one such cooling channel extends in the respective tooth gap. Advantageously, the secondary insulation surrounds the respective cooling channel continuously and circumferentially over its entire axial length. In modifications, however, the respective cooling channel can instead also be open, at least in portions, in the direction of the motor axis, i.e. radially inwards. The circumferential wall of the respective cooling channel can be formed by a tubular insert which is embedded in the secondary insulation. More preferably, however, the secondary insulation, i.e. the insulation material from which the secondary insulation is formed, directly forms the channel wall. The respective cooling channel can in particular be formed as a straight axial passage and/or can emerge at axially opposite end-facing sides of the secondary insulation.

It is advantageous if the respective cooling channel exhibits throughout its entire length a cross-section which is at least half the size of the cross-sectional area of the respective tooth gap as measured between the adjacent coils. The closer the cooling fluid is to the stator core and/or the coils as it flows through the respective cooling channel, the more effectively the heat is discharged from the stator core and/or the coils.

When the pump is in operation, the stator can be cooled from the clearance and the internal cooling channels of the stator. The combination of the clearance cooling system and the cooling channel cooling system enables more intensive and therefore more effective cooling of the stator and simultaneously the rotor which benefits directly from the clearance cooling system and indirectly via the stator from the cooling channel cooling system. The cooling fluid can flow through the drive motor at a higher flow rate than either of the two measures taken alone. The overall heat exchange area available for convection is larger and offers a greater scope for optimisation. In addition, the coils are cooled from the inside, via the stator teeth and the primary insulation which advantageously is thermally conductive, and from the outside from the tooth gaps via the secondary insulation which advantageously is thermally conductive. In addition, it may be noted that in advantageous embodiments, the pump is designed such that a cooling fluid flows through both the clearance and the cooling channels when the pump is in operation. The fluid delivered by the impeller can in particular serve as the cooling fluid.

The primary insulation shields the coils from the stator core and the cooling fluid which penetrates between the stator laminations when the stator core is designed as a laminated core. The secondary insulation shields the coils from the outside on the end-facing sides of the stator and, in conjunction with the primary insulation, serves to shield them from the cooling fluid which in advantageous embodiments flows through the clearance. Advantageously, the primary and secondary insulation in conjunction envelop the coils and shield them from the ingress of cooling fluid. The respective insulation material should be an electrical insulator, but is advantageously a good thermal conductor.

The primary insulation and the secondary insulation are connected in a fluid seal, i.e. which is impermeable to the fluid, continuously and circumferentially around the respective stator tooth, at least in the region of the tooth ends. The fluidically sealed connection can in particular be based on a material bond, i.e. the primary insulation and the secondary insulation can be connected in a material bond, for example glued or preferably fused, to each other, at least in the region of the tooth ends, in a joining zone which annularly encircles the respective stator tooth in a way which is impermeable to the fluid. The joining zone which is formed around the respective stator tooth in the region of the tooth end, if such a particular joining zone is provided, extends between the running surface and the coil of the stator tooth.

In order to more reliably ensure the strength of seal of the connection, the primary insulation and the secondary insulation can comprise one or more joining geometries, adjacent to each other in the region of the tooth ends, which continuously encircle the respective stator tooth and which interlock and, when engaged, form an annular joining zone which is impermeable to the fluid. The respective joining geometry can be a projection or recess which encircles the respective stator tooth. Preferably, one or more (adjacently arranged) projections continuously encircle(s) each of the stator teeth in the region of the tooth end. The respective projection can take the form of an annular disc which terminates at its periphery in a convexly rounded profile or tapers to a point or angularly. The primary insulation and the secondary insulation can form a joining zone, which extends annularly around the respective stator tooth, in the region of the tooth ends, wherein in said joining zone, a microstructure of the primary insulation and a microstructure of the secondary insulation interlock more deeply than at the base of the tooth gaps. The depth of engagement is measured on the circumference of the respective stator tooth, orthogonally with respect to the circumferential surface of the stator tooth which is in contact with the primary insulation. In advantageous embodiments, the primary insulation surrounds the respective stator tooth in the manner of a skin. The depth of engagement is accordingly measured orthogonally with respect to this “skin”.

The one or more joining geometries of the primary insulation and the one or more joining geometries of the secondary insulation can interlock in a positive and/or frictional fit and produce the required strength of seal in said positive and/or frictional fit. They are preferably connected in a material bond, for example glued or advantageously fused, to each other in the annular joining zone. If they are only fused superficially, then the joining geometries are still engaged even after being fused, even though the joining geometries can be deformed by being surface-fused as compared to their shape before being surface-fused. The joining geometries can in particular mesh with each other. The engagement can correspond geometrically to a labyrinth gasket, but with the difference that no relative movement can occur between the mutually engaged joining geometries. If the joining geometries are completely melted, the annular joining zone can be characterised by a fused structure produced by the fusing process. If the primary insulation and secondary insulation consist of the same material and the respective joining geometry is completely melted, the joining zone formed at the respective tooth end can also be characterised only by the fact that it has no discernible transition between the primary insulation and the secondary insulation. In such embodiments, a transition can however still be discernible alongside the annular joining zone, radially further away from the clearance, and/or at the base of the tooth gaps. In principle, however, the primary insulation and secondary insulation can also be completely fused to each other, partially or completely with no discernible transition, outside the particular joining zones obtained in the region of the tooth ends.

It is advantageous if the respective joining geometry of the primary insulation comprises one or more edges on its outer circumferential periphery which is exposed before the secondary insulation is produced, for example because it tapers to a point or comprises a flat, cylindrical circumferential periphery which exhibits two edges. Such a circumferential periphery is conducive to surface-fusing, in particular when the primary insulation is formed such that the respective joining geometry of the primary insulation can be surface-fused at the one or more edges when forming the secondary insulation.

In order to improve the strength of seal between the primary insulation and the secondary insulation, there are also other options as an alternative to or in addition to meshing. The primary insulation can for example be subjected to plasma/corona activation and/or laser structuring, in the joining zone or over the entire area of contact, before the secondary insulation is formed. Alternatively or additionally, it can be chemically activated in the joining zone or over the entire area of contact. After the primary insulation and secondary insulation have been injection-moulded, the two insulations which are in contact can be latterly sealed off, for example using a liquid sealant which is suctioned or pressed into the sealing gaps between the two insulations by producing a pressure differential, as is for example known from vacuum-sealing methods for castings.

In advantageous embodiments, the primary insulation is formed from an electrically insulating first plastic, and the secondary insulation is formed from an electrically insulating second plastic, and the primary insulation and the secondary insulation are fused to each other in the region of the tooth ends in a joining zone which extends annularly around the respective stator tooth, as discussed above. The first plastic and the second plastic can form a fused or mixed structure in the annular joining zone. If the primary insulation and the secondary insulation are also fused to each other outside the annular joining zone, for example at the base of the tooth gaps, then the mixed structure in the annular joining zone exhibits a greater depth than a fused or mixed structure at the base of the tooth gaps. The greater depth can be produced by the primary insulation comprising one or more joining geometries in the region of the subsequent annular joining zone before the secondary insulation is produced, for example one or more projections which encircle the respective stator tooth and/or one or more recesses which encircle the respective stator tooth. Advantageously, the primary insulation is formed with one or more projections which encircle the respective stator tooth.

If the secondary insulation is formed by injection moulding, as is preferred, the primary insulation can be surface-fused or completely melted, in particular in the region of the respective joining geometry, when the secondary insulation is injection-moulded, resulting in a particularly intimate material bond between the first plastic and the second plastic in the annular joining zone. The respective joining geometry which protrudes, exposed, into the molten mass of the secondary insulation at the beginning of injection-moulding the secondary insulation exhibits a large heat-introducing surface compared to its mass, resulting in a rapid surface-fusing and/or melting of the joining geometry as compared to a smooth surface of the primary insulation and, after cooling, a materially bonded, fluidically sealed connection between the primary and secondary insulation.

The first plastic and the second plastic can be the same material, such that their designation as “first plastic” and “second plastic” merely refers to when they are produced. In alternative embodiments, the first plastic and the second plastic can differ in relation to their polymer material. If the first plastic and/or the second plastic (each) exhibits a polymer matrix and comprises one or more fillers in the polymer matrix, the first plastic and the second plastic can differ in relation to the material of the polymer matrix and/or in relation to one or more of the fillers. If the two plastics differ from each other by a polymer component and/or a filler and the joining geometries are completely fused to each other in the respective joining zone, the fused structure of the joining zone exhibits a smaller concentration gradient in relation to said polymer component and/or filler than at the base of the tooth gaps.

Both thermoplastics and thermosets can be considered for the plastics. Each insulation can be thermoplastic or thermosetting. In principle, a thermosetting primary insulation can also be combined with a thermoplastic secondary insulation, or a thermoplastic primary insulation can instead be combined with a thermosetting secondary insulation.

In advantageous embodiments, the primary insulation and the secondary insulation together envelop the coils in order to electrically insulate them from each other and from the stator core and thus from fluid in the engine space. The primary insulation can surround the stator teeth beyond the coils in the direction of the tooth ends. It can envelop the stator core all the way up to the tooth ends, for example in the form of a skin, such that only the tooth ends do not comprise the primary insulation, at least on their respective running surface which delineates the clearance. The secondary insulation can envelop the stator core and the coils, such that only the tooth ends do not comprise the secondary insulation, at least on their respective running surface, wherein connector elements for electrically connecting the coils can lead through the secondary insulation.

In a first variant, the primary insulation envelops the stator core right up to the running surfaces of the stator teeth, and the secondary insulation fills the tooth gaps right up to the running surfaces of the stator teeth, such that the running surfaces of the stator teeth and the insulation material in the tooth gaps terminate flush with each other. This enables turbulence in the cooling fluid in the clearance to kept low. In a second variant, the insulation material in the tooth gaps is radially set back slightly from the running surfaces, such that the running surfaces are radially exposed. In the first variant, the running surfaces of the stator core and the insulation material in the tooth gaps together advantageously form a smooth, circular-cylindrical running surface of the stator. In the second variant, the exposed running surfaces of the stator core together advantageously form a circular-cylindrical running surface of the stator which protrudes beyond the tooth gaps towards the rotor.

The rotor of the drive motor and the impeller can be arranged coaxially and such that they can be rotated about the rotational axis which in this case is a shared rotational axis. The rotor and the drive motor are coupled by means of a drive shaft for transmitting torque. Preferably, they are non-rotationally connected to the drive shaft. The drive shaft can advantageously be formed as a hollow shaft.

In order to cool the drive motor, a cooling path for the cooling fluid can extend from a cooling path inlet up to and through the clearance and/or up to and through the respective cooling channel of the stator and continue up to a cooling path outlet. The cooling path inlet and the cooling path outlet can emerge into a main flow of the fluid which can be delivered by means of the impeller in order to divert fluid for cooling the drive motor from the main flow and feed it back into the main flow through the engine space. Advantageously, the cooling path inlet is arranged in a higher-pressure region in the main flow, and the cooling path outlet is arranged in a lower-pressure region in the main flow, such that there is a pressure differential between the cooling path inlet and the cooling path outlet when the pump is in operation, wherein the pressure differential alone is sufficient as a driving force to deliver the fluid along the cooling path through the engine space.

The cooling path inlet and/or the cooling path outlet can (each) emerge in the delivery housing in order to divert fluid for cooling the drive motor within the pump from the main flow and/or feed it back into the main flow. The cooling path inlet can then emerge in a higher-pressure fluid region in the delivery housing and/or the cooling path outlet can emerge in a lower-pressure fluid region in the delivery housing. The cooling path inlet can in particular emerge into the delivery chamber, for example downstream of the impeller in the region of the outlet or between the impeller and the outlet. The cooling path outlet can advantageously emerge upstream of the impeller in the region of the inlet or in particular on the front side of the impeller in the direction of the inlet.

The cooling path can bifurcate, between the higher-pressure region and the lower-pressure region, into a first path which leads through the clearance and a second path which leads through the respective cooling channel of the stator. It can bifurcate into the two paths downstream of the cooling path inlet. More preferably, it bifurcates while still in the higher-pressure region, by providing a first cooling path inlet and, separately, a second cooling path, wherein fluid flows via the first cooling path inlet to the clearance and via the second cooling path inlet to the cooling channels of the stator.

The two cooling paths can converge in the lower-pressure region. Preferably, they converge while still in the engine space, downstream of the clearance and the cooling channels, such that the fluid is discharged from the engine space via the cooling path outlet shared by the two paths and preferably fed back into the main flow. If the drive shaft is a hollow shaft, the fluid can advantageously be fed back via the drive shaft, wherein the drive shaft or the impeller can form the cooling path outlet.

In advantageous embodiments, the secondary insulation surrounds the wound stator core over its outer circumference. Beyond its enveloping function, it can advantageously be further developed into a motor housing. The delivery housing can be joined directly to this motor housing, for example by means of a screw connection.

The secondary insulation can form a connector housing for one or more electrical connector elements via which the drive motor can be connected to an external system for supplying power and/or controlling. The connector housing can be designed for a plugging connection with a correspondingly shaped connector. The respective connector element can be embedded in the secondary insulation and thus positioned and fixed relative to the motor housing and the connector housing. The respective electrical connector element can then comprise an inner connector contact, an outer connector contact and a connecting portion which connects the inner connector contact to the outer connector contact. The connecting portion can be embedded in the secondary insulation. The inner connector contact can protrude from the secondary insulation in order to electrically connect motor electronics. The outer connector contact can protrude from the secondary insulation for electrically connecting to the external system in the connector housing.

The secondary insulation can comprise an assembly geometry which serves to assemble the pump at the desired point of installation. The assembly geometry can be formed directly as the secondary insulation is formed by primary moulding. It can comprise one or more assembly elements, for example one or more protruding assembly flanges. The assembly geometry can in particular be designed for assembling the pump by means of a screw connection. The assembly geometry can for example form one or more exposed passages for a fastening element, or each for one fastening element, such as for example a screw. The assembly geometry can comprise one or more elastic joining elements which are joined to the secondary insulation, for example in a positive fit and/or in a frictional fit, and which are directly in contact with an associated fastening element when the pump is assembled. When the pump is assembled, the respective elastic joining element acts as a damper between a unit on which the pump is assembled, for example a drive motor or transmission or a motor vehicle body, and the pump.

Beyond its enveloping function, the secondary insulation can advantageously be further developed into a rotary bearing structure for rotationally mounting the rotor, wherein the secondary insulation and the rotary bearing structure are advantageously formed in one piece by primary moulding, for example as a casting made of plastic. The rotary bearing structure can comprise one or more passages. The cooling path described above can extend upstream or downstream of the clearance through the respective passage of the rotary bearing structure.

Motor electronics comprising a circuit board and electronic components arranged on the circuit board for supplying power to and controlling the drive motor can be an integral component of the pump. The secondary insulation can be formed with joining elements which are in joining engagement with the circuit board and fix the circuit board relative to the stator due to the joining engagement. These joining elements can for example protrude in the shape of pins on a rear side of the stator which faces away from the impeller and protrude through the circuit board. The joining elements can form connecting rivets, such that the circuit board is joined to the stator by means of a rivet connection, for example a hot-rivet connection.

The secondary insulation is advantageously formed in one piece in a primary moulding process, for example as a casting made of plastic. With regard to the additional functionality described above, this means that the secondary insulation can advantageously be formed in the primary moulding process together with a motor housing which surrounds the stator core and/or together with a connector housing for electrically connecting to an external system for supplying power to and/or controlling the drive motor and/or together with a rotary bearing structure for radially bearing a drive shaft which is non-rotationally connected to the rotor and/or the impeller.

The additional functionalities of the secondary insulation can advantageously be realised, each individually and more advantageously in any combination. Each of the additional functionalities can be realised without Feature 1.8, i.e. the primary insulation and/or the secondary insulation can also cover the running surface of the stator. Similarly, each of the additional functionalities can be realised without Feature 1.9, i.e. the stator does not comprise cooling channels of the type in accordance with an aspect of the invention or does not comprise any channels for fluid at all. Conversely, each of the additional functionalities can be realised with Feature 1.8 or instead with Feature 1.9 of claim 1, i.e. without the respective other feature, or preferably with both Features 1.8 and 1.9 of claim 1.

The pump can for example be embodied as a centrifugal pump, in particular as a radial centrifugal pump, and the impeller can be a radial impeller. The drive motor can be embodied as an external rotor, and the rotor can surround the stator, such that the running surface of the stator is an outer circumferential surface. Preferably, however, the drive motor is an internal rotor, and the stator surrounds the rotor, such that the running surface of the stator is an inner circumferential surface. The rotor is preferably equipped with permanent magnets, but can instead also be provided with electrical coils. In principle, the situation can also be reversed, such that only the rotor is provided with electrical coils and the stator is equipped with permanent magnets. In such embodiments, the permanent magnets replace the coils of the stator. The additional cooling which can be achieved by means of the cooling channels of the stator, in addition to the clearance cooling, is also advantageous for such modifications. The cooling channels can then for example extend between the permanent magnets of the stator in the axial direction through the stator.

The pump can in particular be designed for use as a cooling medium pump for delivering a water/glycol mixture and/or a dielectric heat transfer oil for cooling or tempering one or more components of an engine-driven vehicle such as a motor vehicle. More specifically, it can be designed in such an application for tempering
an internal combustion engine and/or
drivetrain components of a drivetrain for a combustion-driven vehicle and/or
components of the drive train of a battery-driven electric vehicle and/or
the battery cells of a traction battery of a motor vehicle.

The expression “for tempering” means that the pump is only designed for cooling or only for heating or, depending on requirements, for both cooling and heating. The pump can in particular be designed as a cooling medium pump for delivering a dielectric heat transfer oil for tempering by direct heat exchange, i.e. for directly cooling and/or directly heating the battery cells of a traction battery of a motor vehicle.

In advantageous embodiments, the pump is embodied for actuating at variable rotational speeds by a vehicle control device or motor control device and can be actuated by the vehicle control device or motor control device in accordance with one or more measured variables, such as for example the outside temperature and/or a temperature of a vehicle component to be tempered.

An aspect of the invention also relates to a method for producing a stator for an electric drive motor, preferably the stator for the drive motor of the pump disclosed in this document. The method comprises at least the following steps:
An electrically insulating first plastic is moulded around a stator core which comprises stator teeth (which at least substantially point radially with respect to a motor axis and exhibit exposed tooth ends) and tooth gaps which remain between the stator teeth, to form a primary insulation which surrounds the stator teeth and preferably lines the tooth gaps. This can also be referred to as the primary injection-moulding process.
Electrical lines are wound around the stator teeth provided with the primary insulation, to form electrical coils.
An electrically insulating second plastic is moulded around the stator core and coils, to form a secondary insulation which envelops the coils and the stator core beyond the coils and up to the tooth ends. This can also be referred to as the secondary injection-moulding process.
When injection-moulding the secondary insulation, cooling channels which extend in the axial direction through the secondary insulation are formed in the region of the tooth gaps in order to channel a fluid which serves to cool the stator.
At the tooth ends, the stator comprises circumferential or running surfaces for forming a clearance with a rotor of the drive motor. These running surfaces do not comprise the primary insulation or the secondary insulation. For this purpose, the plastic of the primary insulation can initially also be injection-moulded around the running surfaces in the primary injection-moulding process and/or the plastic of the secondary insulation can initially also be injection-moulded around the running surfaces in the secondary injection-moulding process, and the respective plastic on the running surfaces can be removed in a machine-finishing step. Advantageously, however, both the primary injection-moulding process and the secondary injection-moulding process are embodied such that the running surfaces continue to not comprise the respective plastic even during primary injection-moulding process and the secondary injection-moulding process.

Advantageously, the primary insulation is injection-moulded in the region of the tooth ends with one or more joining geometries in the form of one or more projections and/or recesses which encircle the respective stator tooth. When the secondary insulation is injection-moulded, the respective joining geometry is surface-fused or melted in contact with the second plastic, such that if it is only surface-fused, the respective joining geometry engages the secondary insulation after cooling or, if it is melted, the respective joining geometry microscopically forms a mixed structure with the first plastic.

Features of the invention are also described in the aspects formulated below. The aspects are worded in the manner of claims and can substitute for them. Features disclosed in the aspects can also supplement and/or qualify the claims, indicate alternatives with respect to individual features and/or broaden claim features. Bracketed reference signs refer to example embodiments of the invention illustrated below in figures. They do not restrict the features described in the aspects to their literal sense as such, but do conversely indicate preferred ways of realising the respective feature.
1. A pump for delivering a fluid, for example a cooling fluid and/or a lubricating fluid, the pump comprising:
   1.1. a delivery housing (1, 4) featuring an inlet (2) and an outlet (3) for the fluid;
   1.2. an impeller (15) which can be rotated in the delivery housing (1, 4) for delivering the fluid from the inlet (2) to the outlet (3); and
   1.3. an electric drive motor (10, 20) comprising a rotor (10), which can be rotated about a motor axis (R) and is coupled to the impeller (15) in order to drive it, and a stator (20) which together with the rotor (10) forms a clearance (14) around the motor axis (R), the stator (20) comprising:
      1.4. a stator core (21, 22, 23) featuring stator teeth (21), which at least substantially point radially with respect to the motor axis (R), and tooth gaps which remain between the stator teeth (21);
      1.5. electrical lines which are wound around the stator teeth (21), to form electrical coils (25);
      1.6. a primary insulation (26) which is formed between the respective stator tooth (21) and the coil (25) which surrounds the respective stator tooth (21), in order to electrically insulate it;
      1.7. and a secondary insulation (28) which is formed in the tooth gaps in order to electrically insulate adjacent coils (25),
   1.8. wherein the stator teeth (21) each comprise a running surface (24) at tooth ends (23) which radially faces opposite the rotor (10) across the clearance (14) and optionally does not comprise the primary insulation (26) and/or the secondary insulation (28),
   1.9. and/or in (each of) one or more of the tooth gaps, a cooling channel (29) through which coolant can flow optionally extends in the axial direction through the secondary insulation (28).
2. The pump according to the preceding aspect, wherein the primary insulation (26) and the secondary insulation (28) are connected circumferentially around the respective stator tooth (21) in a way which is impermeable to the fluid, at least in the region of the tooth ends (23), preferably in a material bond, such that the coils (25) are separated from the clearance (14).
3. The pump according to the preceding aspect, wherein the primary insulation (26) and the secondary insulation (28) are connected in a material bond, preferably fused, in a joining zone which annularly encircles the respective stator tooth (21) and in a way which is impermeable to the fluid, at least in the region of the tooth ends (23).
4. The pump according to any one of the preceding aspects, wherein the primary insulation (26) surrounds the stator teeth (22) in the region of the coils (25), preferably lines the tooth gaps up to the vicinity of each of the tooth ends (23), and is connected in a material bond, for example fused, to the secondary insulation (28) in a joining zone which annularly encircles the respective stator tooth (21) and in a way which is impermeable to the fluid, at least in the region of the tooth ends (23).
5. The pump according to any one of the preceding aspects, wherein the primary insulation (26) and the secondary insulation (28) comprise one or more joining geometries (27; 27a), in the region of the tooth end (23) of the respective stator tooth (21), which encircle the respective stator tooth (21) and interlock to form, when engaged, an annular joining zone which is impermeable to the fluid.
6. The pump according to any one of the preceding aspects, wherein the primary insulation (26) and the secondary insulation (28) comprise one or more projections (27; 27a) which encircle the respective stator tooth (21) and correspondingly one or more recesses, in the region of the tooth end (23) of the respective stator tooth (21), which interlock to form, when engaged, an annular joining zone which is impermeable to the fluid.
7. The pump according to any one of the preceding aspects, wherein the primary insulation (26) and the secondary insulation (28) form an annular joining zone, circumferentially around the respective stator tooth (21) in the region of the tooth end (23) of the respective stator tooth (21), in which they are fused to each other over an enlarged contact area as compared to a joining region located at the base of the respective tooth gap.
8. The pump according to any one of the preceding aspects, wherein the primary insulation (26) and the secondary insulation (28) form, in the region of the tooth ends (23), a joining zone which extends annularly around the respective stator tooth (21) and in which a microstructure of the primary insulation (26) and a microstructure of the secondary insulation (28) interlock more deeply than at the base of the tooth gaps.
9. The pump according to any one of the preceding aspects, wherein
   the primary insulation (26) consists of a first plastic and the secondary insulation (28) consists of a second plastic,
   the primary insulation (26) and the secondary insulation (28) are fused in the region of the tooth ends (23) in a joining zone which extends annularly around the respective stator tooth (21), and
   a mixed structure which is formed by the first plastic and the second plastic exhibits a greater depth (d) in the annular joining zone than at the base of the tooth gaps.
10. The pump according to any one of the preceding aspects, wherein in the region of the tooth end (23) of the respective stator tooth (21), the primary insulation (26) and the secondary insulation (28) comprise one or more projections (27; 27a) which encircle the respective stator tooth (21), and correspondingly one or more recesses, which interlock in a seal and preferably mesh with each other.
11. The pump according to the preceding aspect, wherein the respective projection (27; 27a) comprises an outer circumferential periphery featuring one or more edges and/or one or more surface-fused edges.
12. The pump according to any one of the preceding aspects, wherein the primary insulation (26) and the secondary insulation (28) mesh with each other, preferably circumferentially around the respective stator tooth (21), in the region of the tooth end (23) of the respective stator tooth (21).
13. The pump according to any one of the preceding aspects, wherein the secondary insulation (28) extends in the tooth gaps towards the motor axis (R), beyond the primary insulation (26) and enclosing the primary insulation (26), in the region of the tooth ends (23) up to the flanks of the tooth ends (23).
14. The pump according to the preceding aspect, wherein the first plastic and the second plastic differ in relation to a polymeric component and/or in relation to a filler.
15. The pump according to any one of the preceding aspects, wherein the primary insulation (26) and the secondary insulation (28) together envelop the coils (25) and electrically insulate them from each other and from the stator core (21, 22, 23).
16. The pump according to any one of the preceding aspects, wherein the primary insulation (26) lines the tooth gaps of the stator core (21, 22, 23).
17. The pump according to any one of the preceding aspects, wherein the stator (20) comprises a stator yoke (22) which extends annularly around the rotational axis (R) and from which the stator teeth (21) protrude, and the primary insulation (26) covers the circumference of the stator yoke (22) which faces away from the stator teeth (21).
18. The pump according to any one of the preceding aspects, wherein the primary insulation (26) envelops the stator core (21, 22, 23) all the way up to the tooth ends (23), such that only the tooth ends (23) respectively do not comprise the primary insulation (26), at least on their running surface (24) which delineate the clearance (14).
19. The pump according to any one of the preceding aspects, wherein the secondary insulation (28) envelops the stator core (21, 22, 23) and the coils (25), such that only the tooth ends (23) respectively do not comprise the secondary insulation (28), at least on their running surface (24) which delineates the clearance (14), and connector lines (25a) for the coils (25) lead through the secondary insulation (28).
20. The pump according to any one of the preceding aspects, wherein the secondary insulation (28) envelops the stator core (21, 22, 23) and the coils (25) all the way up to the tooth ends (23), such that only the tooth ends (23) of the stator core (21, 22, 23) respectively do not comprise the second insulation (28), at least on their running surface (24) which delineates the clearance (14).
21. The pump according to any one of the preceding aspects, wherein the secondary insulation (28) fills the tooth gaps of the stator core (21, 22, 23) between the adjacent coils (25) around the respective cooling channel (29).
22. The pump according to any one of the preceding aspects, wherein the secondary insulation (28) directly surrounds the respective cooling channel (29), such that it directly forms the circumferential wall of the respective cooling channel (29).
23. The pump according to any one of the preceding aspects, wherein the respective cooling channel (29) is a passage which extends in the axial direction, preferably a straight, axial passage, through the secondary insulation (28).
24. The pump according to any one of the preceding aspects, wherein the respective cooling channel (29) is closed over the axial length of the clearance (14).
25. The pump according to any one of the preceding aspects, wherein the secondary insulation (28) directly surrounds the respective cooling channel (29) over the axial length of the clearance (14), such that it directly forms the circumferential wall of the respective cooling channel (29) over the axial length of the clearance (14).
26. The pump according to any one of the preceding aspects, wherein the respective cooling channel (29) is open radially inwards, towards the motor axis (R), at least in a partial portion of its axial length.
27. The pump according to any one of the preceding aspects, wherein a cooling path for the fluid extends from a cooling path inlet (4a, 4b), which emerges in a higher-pressure region in the delivery housing (1, 4), through the clearance (14) and/or the respective cooling channel (29) up to a cooling path outlet (16a) which emerges in a lower-pressure region in the delivery housing (1, 4).
28. The pump according to the preceding aspect, wherein the cooling path bifurcates, between the higher-pressure region and the lower-pressure region, into a first path which leads through the clearance (14) and a second path which leads through the respective cooling channel (29).
29. The pump according to any one of the immediately preceding two aspects, comprising a drive shaft (16) which couples the rotor (10) of the drive motor (10, 20) to the impeller (15) for transmitting torque, wherein the cooling path extends in the axial direction through the drive shaft (16).
30. The pump according to the preceding aspect, wherein the drive shaft (16) forms the cooling path outlet (16a).
31. The pump according to any one of the preceding aspects, wherein the rotor (10) of the drive motor (10, 20) and the impeller (15) are arranged coaxially and such that they can be rotated about the shared rotational axis (R).
32. The pump according to any one of the preceding aspects, wherein the rotor (10) of the drive motor (10, 20) and the impeller (15) are non-rotationally connected.
33. The pump according to any one of the preceding aspects, wherein
   the impeller (15) is arranged in a delivery chamber and the drive motor (10, 20) is arranged in an engine space, and they are coupled by means of a drive shaft (16) for transmitting torque,
   the delivery housing (1, 4) comprises a rear wall (4) on an end-facing side which axially faces the engine space, and
   the drive shaft (16) protrudes through this rear wall (4).
34. The pump according to any one of the preceding aspects, wherein the rotor (10) of the drive motor (10, 20) and the impeller (15) are arranged coaxially along a drive shaft (16) which can be rotated about the rotational axis (R) and which is preferably formed as a hollow shaft.
35. The pump according to the preceding aspect, wherein the rotor (10) of the drive motor (10, 20) and the impeller (15) are each non-rotationally connected to the drive shaft (16).
36. The pump according to any one of the preceding aspects, wherein the secondary insulation (28) forms a motor housing (6).
37. The pump according to any one of the preceding aspects, comprising a motor housing (6) which envelops the stator core (21, 22, 23) and the coils (25) all the way up to the tooth ends (23), such that only the tooth ends (23) remain exposed at least on their running surface (24) which delineates the clearance (14).
38. The pump according to the preceding aspect, wherein the secondary insulation (28) forms the motor housing (6).
39. The pump according to any one of the preceding aspects, wherein the secondary insulation (28) is formed in one piece in a primary moulding process, for example as a casting made of plastic.
40. The pump according to any one of the preceding aspects, wherein the secondary insulation (28) is formed in one piece, for example as a casting made of plastic, in a primary moulding process together with a motor housing (6) which surrounds the stator core (21, 22, 23) and/or together with a connector housing (7) for electrically connecting to an external system for supplying power to and/or controlling the drive motor (10, 20) and/or together with a rotary bearing structure (8) for radially bearing a drive shaft (16) which is non-rotationally connected to the rotor (10) and/or the impeller (15).
41. The pump according to the preceding aspect, wherein the motor housing (6) comprises one or more joining elements (6a), which are integrally moulded in the primary moulding process, for joining to the delivery housing (1, 4) and/or joining elements (6b), which are integrally moulded in the primary moulding process, for joining to a motor electronics circuit board (33) equipped with electronic components (34).
42. The pump according to any one of the immediately preceding two aspects, wherein the rotary bearing structure (8) comprises a central bearing structure which surrounds the drive shaft (16) and a connecting support which extends in the radial direction and supports the central bearing structure on the stator (20).
43. The pump according to any one of the preceding aspects, wherein the secondary insulation (28) comprises an assembly geometry (6c), which is integrally moulded in a primary moulding process, for assembling the pump at a point of installation.
44. The pump according to any one of the preceding aspects, wherein the secondary insulation (28) forms a motor housing (6), and the delivery housing (1, 4) is joined directly to the motor housing (6), preferably directly to the secondary insulation (28), for example by means of a screw connection (6a, 9).
45. The pump according to any one of the preceding aspects, wherein the secondary insulation (28) forms a connector housing (7) for one or more electrical connector elements (42, 46), and the stator (20) can be connected via the connector housing (7) and the respective connector element (42, 46) to an external system for supplying power and/or controlling, for example by means of a plugging contact connection.
46. The pump according to the preceding aspect in combination with any one of aspects 36, 37, 40 and 44, wherein the respective electrical connector element (42, 46) is embedded in the secondary insulation (28) and thus positioned and fixed relative to the motor housing (6) and/or the connector housing (7).
47. The pump according to the preceding aspect, wherein the respective electrical connector element (42, 46) comprises an inner connector contact (43), an outer connector contact (45) and a connecting portion (44) which connects the inner connector contact (43) to the outer connector contact (45), and wherein the connecting portion (44) is embedded in the secondary insulation (28), the inner connector contact (43) for electrically connecting motor electronics (34) protrudes from the secondary insulation (28), and the outer connector contact (45) for electrically connecting to the external system in the connector housing (7) protrudes from the secondary insulation (28).
48. The pump according to any one of the immediately preceding three aspects, wherein the respective electrical connector element (42, 46) exhibits a greater roughness, for example fluting, in a portion (44) which is embedded in the secondary insulation (28) than in a region which protrudes from the secondary insulation, in order to improve sealing in the region where it is embedded.
49. The pump according to any one of the preceding aspects, comprising a rotary bearing structure (8) for rotationally mounting the rotor (10), wherein the secondary insulation (28) and the rotary bearing structure (8) are formed in one piece by primary moulding, for example as an injection-moulded part made of plastic.
50. The pump according to the preceding aspect in combination with aspect 27, wherein the cooling path extends upstream or downstream of the clearance (14) through one or more passages (8a) of the rotary bearing structure (8).
51. The pump according to any one of the preceding aspects, each in combination with aspects 25 and 33, wherein the cooling path extends upstream of the clearance (14) and/or the respective cooling channel (29) through the rear wall (4) of the delivery housing (1, 4).
52. The pump according to any one of the preceding aspects, each in combination with aspect 27 and any one of aspects 29, 33 ,34 and 40, wherein the cooling path extends downstream of the clearance (14) through the drive shaft (16).
53. The pump according to any one of the preceding aspects, comprising motor electronics comprising a circuit board (33) and electronic components (34) arranged on the circuit board (33) for supplying power to and controlling the drive motor (10, 20), wherein the secondary insulation (28) is formed with joining elements (6b) which are in joining engagement with the circuit board (33) and fix the circuit board (33) relative to the stator (20) due to the joining engagement.
54. The pump according to the preceding aspect, wherein the joining elements (6b) protrude in the shape of pins on a rear side of the stator (20) which faces away from the impeller (15) and protrude through the circuit board (33).
55. The pump according to any one of the immediately preceding two aspects, wherein the joining elements (6b) form connecting rivets, such that the circuit board (33) is joined to the stator (20) by means of a rivet connection, for example a hot rivet connection.
56. The pump according to any one of the preceding aspects, each in combination with any one of aspects 36, 37, 40 and 44, comprising:
   an end-facing wall (30) which closes off the motor housing (6) on an end-facing side; and
   a circuit board (33) comprising motor electronics (34) for controlling and/or supplying power to the stator (20),
   wherein the circuit board (33) is arranged on an end-facing side of the end-facing wall (33) which axially faces away from the stator (20).
57. The pump according to the preceding aspect, wherein the motor housing (6) comprises joining elements (6b) which are integrally moulded on the motor housing (6) and protrude through the end-facing wall (30) and the circuit board (33) and form connecting rivets, such that the end-facing wall (30) and the circuit board (34) are joined to the motor housing (6) by means of a rivet connection, for example a hot rivet connection.
58. The pump according to any one of the preceding aspects, wherein the impeller (15) is a radial impeller.
59. The pump according to any one of the preceding aspects, wherein the delivery housing (1, 4) forms a delivery chamber which spirals around the rotational axis (R) of the impeller (15).
60. The pump according to any one of the preceding aspects, wherein the inlet (2) of the delivery housing (1, 4) guides the fluid to the impeller (15), coaxially with respect to the rotational axis (R).
61. The pump according to any one of the preceding aspects, wherein the stator (20) surrounds the rotor (10).
62. The pump according to any one of the preceding aspects, wherein the clearance (14) exhibits a radial clearance width w which is measured radially with respect to the rotational axis (R) between the running surface (24) of one of the stator teeth (23) and an opposing circumference of the rotor (10) across the clearance (14), and the primary insulation (26) exhibits a thickness D in the region of the tooth ends (23), where w<D or w<0.5×D.
63. The pump according to any one of the preceding aspects, wherein
   the primary insulation (26) and the secondary insulation (28) are radially set abutting contact from the running surfaces (24) of the stator teeth (23) in the region of the tooth gaps
   or instead
   the primary insulation (26) and the secondary insulation (28) terminate flush with the running surfaces (24) of the stator teeth (23) in the region of the tooth gaps.
64. The pump according to any one of the preceding aspects, wherein the stator teeth (21) and the secondary insulation (28), and optionally the primary insulation (26) as well, together form a running surface (24, 28a) of the stator (21).
65. The pump according to any one of the preceding aspects, wherein the delivery housing (1, 4) comprises a rear wall (4) which is arranged axially between the impeller (15) and the electric drive motor (10, 20) and connected in a material bond, preferably fused, to the secondary insulation (28).
66. The pump according to any one of the preceding aspects, which is embodied as a cooling medium pump for delivering a water/glycol mixture and/or a dielectric heat transfer oil for cooling or tempering (cooling and/or heating)
   an internal combustion engine and/or
   drivetrain components of a drivetrain for a combustion-driven vehicle and/or
   components of the drive train of a battery-driven electric vehicle and/or
   the battery cells of a traction battery of a motor vehicle.
67. The pump according to any one of the preceding aspects, which is embodied as a cooling medium pump for delivering a dielectric heat transfer oil for directly cooling (cooling/tempering) the battery cells of a traction battery of a motor vehicle.
68. The pump according to any one of the preceding aspects, which is embodied for actuating at variable rotational speeds by a vehicle control device or motor control device and is actuated by the vehicle control device or motor control device in accordance with one or more measured variables, such as for example the outside temperature and/or a temperature of a vehicle component to be tempered.
69. A method for producing a stator for an electric drive motor (10, 20), preferably the stator (20) for the drive motor (10, 20) of the pump according to any one of the preceding aspects, comprising the following steps:
   1.1. an electrically insulating first plastic is moulded around a stator core (21, 22, 23) which comprises stator teeth (21), which at least substantially point radially with respect to a motor axis (R) and exhibit exposed tooth ends (23), and tooth gaps which remain between the stator teeth (21), to form a primary insulation (26) which surrounds the stator teeth (21) and preferably lines the tooth gaps;
   1.2. electrical lines are wound around the stator teeth (21) provided with the primary insulation (26), to form electrical coils (25);
   1.3. an electrically insulating second plastic is moulded around the stator core (21, 22, 23) and the coils (25), to form a secondary insulation (28) which envelops the coils (25) and the stator core (21, 22, 23) beyond the coils (25) and up to the tooth ends (23); and
   1.4 when injection-moulding the secondary insulation (28), cooling channels (29) which extend in the axial direction through the secondary insulation (28) are formed in the region of the tooth gaps in order to channel a fluid which serves to cool the stator,
   1.5. wherein at the tooth ends (23), a running surface (24) for forming a clearance (14) with a rotor (10) of the drive motor (10, 20) does not comprise the primary insulation (26) or the secondary insulation (28).
70. The method according to the preceding aspect, wherein the primary insulation (26) and the secondary insulation (28) are injection-moulded such that the running surface (24) continues to not comprise the first plastic or the second plastic during the injection-moulding process.
71. The method according to aspect 68, wherein plastic adhering to the running surface (24) is ablated, preferably by machining, following the injection-moulding process.
72. The method according to any one of the immediately preceding three aspects, wherein the primary insulation (26) is injection-moulded in the region of the tooth ends (23) with one or more joining geometries (27) in the form of one or more projections and/or recesses (27) which encircle the respective stator tooth (21), and the respective joining geometry (27) is surface-fused or melted in contact with the second plastic When the secondary insulation (28) is injection-moulded, such that if it is surface-fused, the respective joining geometry (27) engages the secondary insulation (28) or, if it is melted, the respective joining geometry (27) microscopically forms a mixed structure with the first plastic.
73. The method according to any one of the immediately preceding four aspects, wherein the first plastic and the second plastic differ in relation to a polymeric component and/or in relation to a filler.
74. The method according to any one of the immediately preceding five aspects, wherein once the second plastic has been injection-moulded, any plastic overflow on an inner circumferential surface (24, 28a) is removed by means of subsequent machining, such that the running surface (24) does not comprise the first plastic or the second plastic at the tooth ends (23).

### BRIEF DESCRIPTION OF THE DRAWINGS

An example embodiment of the invention is described below on the basis of figures. Features disclosed by the example embodiments, each individually and in any combination of features, advantageously develop the subject matter of the claims, the aspects and the other embodiments described above. In the figures:

FIG. 1 shows a pump in accordance with an aspect of the invention in an isometric exploded view onto a front side and in an isometric exploded view onto a rear side of the components of the pump;

FIG. 2 shows the pump in a first longitudinal section;

FIG. 3 shows the pump in a second longitudinal section;

FIG. 4 shows the pump in a cross-section;

FIG. 5 shows a detail of FIG. 4;

FIG. 6 shows a stator core, wound with coils, of an electric drive motor of the pump;

FIG. 7 shows a detail of FIG. 6;

FIG. 8 shows a stator of the drive motor in an isometric view onto the front side of the stator;

FIG. 9 shows the stator in an isometric view onto the rear side;

FIG. 10 shows the stator in an isometric exploded view;

FIG. 11 shows the stator together with electrical connector elements separated from the assemblage;

FIG. 12 shows a joining connection for fixing a circuit board equipped with electronic components;

FIG. 13 shows a tooth gap region of the stator, comprising a modified secondary insulation;

FIG. 14 shows the detail X from FIG. 13;

FIG. 15 shows the detail X from FIG. 13, comprising a modified joining geometry; and

FIG. 16 shows an isometric view of a modified motor housing.

### DETAILED DESCRIPTION OF EXEMPLARY EMBODIMENTS

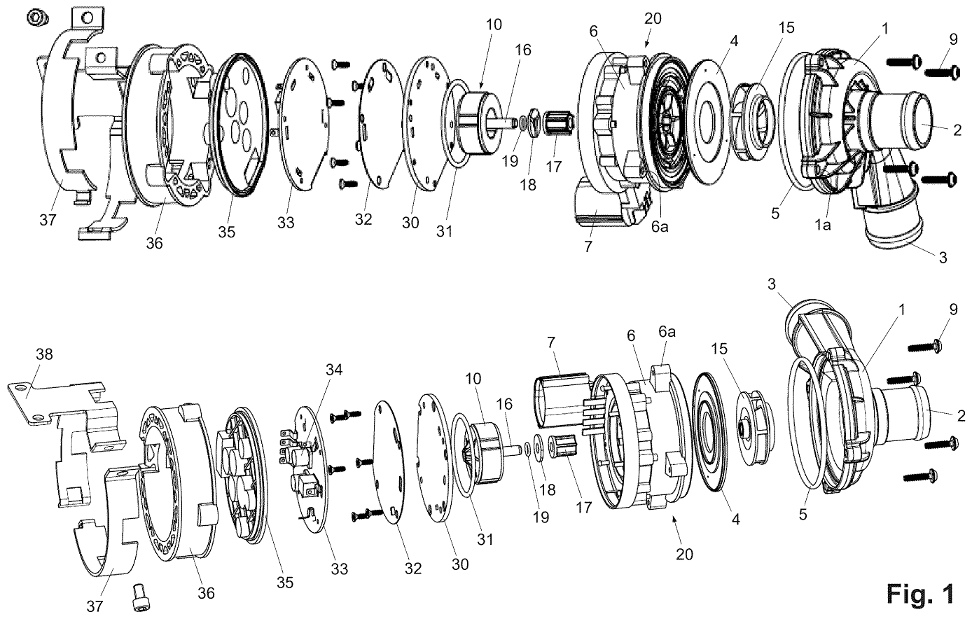

FIG. 1 shows a pump in accordance with an aspect of the invention in two exploded views: the top exploded view is an isometric view onto a front side, and the bottom exploded view is an isometric view onto a rear side of the components of the pump. The pump is functionally divided into a delivery portion comprising an impeller 15, a drive portion comprising an electric drive motor 10, 20 which comprises a rotor 10 and a stator 20, and an electronics portion comprising a circuit board 33 and electronic components 34 for supplying and controlling the drive motor 10, 20. These functional portions are integrated and arranged one behind the other along a motor axis of the drive motor 10, 20 in a multi-part housing.

The delivery portion comprises a delivery housing featuring a housing part 1 and a rear wall 4 which separates the delivery portion from the drive portion when the pump is assembled. The housing part 1 comprises an inlet 2 and an outlet 3 for a fluid to be delivered. The housing part 1 and the rear wall 4 together surround a delivery chamber which connects the inlet 2 to the outlet 3. An annular gasket 5 ensures the fluidically sealed connection between the housing part 1 and the rear wall 4 when the pump is assembled. The housing part 1 can itself be joined from multiple parts, but is preferably formed in one part. The impeller 15 is rotatably accommodated in the delivery chamber in order to deliver the fluid from the inlet 2 into and through the delivery chamber to the outlet 3 when rotationally driven by the drive motor 10, 20.

The pump is embodied as a radial centrifugal pump. Accordingly, the impeller 15 is a radial impeller, and the delivery chamber is a spiral chamber. The inlet 2 guides the fluid in the axial direction centrally into the delivery chamber, while the outlet 3 discharges the fluid in a tangential direction. Alternatively, the pump can also be embodied as a positive displacement pump, for example an internal-axle displacement pump such as for example a vane pump or toothed ring pump. It is however preferably embodied as a centrifugal pump, in particular in applications as a cooling fluid pump.

The drive portion comprises a motor housing 6 which surrounds the stator 20 and is immovably connected to it. A connector housing 7 is moulded on the motor housing 6. The connector housing 7 surrounds electrical connector contacts for connecting the drive motor 10, 20 (in the example embodiment, the stator 20) to an external power supply and/or an external controller, for example a motor controller of a motor vehicle. The connector housing 7 surrounds the connector contacts which, together with the connector housing 7, are designed for a plugging connection with a corresponding plugging connector.

When the pump is assembled, the rotor 10 is accommodated in an engine space which is surrounded by the motor housing 6. The rear wall 4 separates the engine space from the delivery chamber. The drive motor 10, 20 is embodied by way of example as an internal rotor. The rotor 10 is thus surrounded by the stator 20. A drive shaft 16 is non-rotationally connected to the rotor 10. The drive shaft 16 forms the motor shaft of the drive motor 10, 20. A bearing socket 17 and a bearing disc 18 serve to rotationally mount the drive shaft 16 and thus also the rotor 10. An annular gasket 19 performs a sealing function between the rotor 10 and the bearing disc 18 when the pump is assembled.

An end-facing wall 30 closes off the engine space on its rear side which axially faces away from the delivery portion. The end-facing wall 30 serves as a partition wall between the engine space and an electronics space in which electronic components 34 which can be seen in the lower representation are arranged on the circuit board 33. An annular gasket 31 which is arranged between the motor housing 6 and the end-facing wall 30 ensures that the electronics space is separated in a fluidic seal from the engine space. A film-like gap filler 32 is provided between the end-facing wall 30 and the circuit board 33. When the pump is assembled, the disc-shaped end-facing wall 30, the film-like gap filler 32 and the circuit board 33 form an axial layered structure. A cover 35 closes off the electronics space on its rear side.

When the pump is assembled, the delivery housing 1, 4 and the motor housing 6 rest axially against each other and are immovably joined to each other. They are by way of example joined by means of a screw connection. In order to establish the joining connection, the delivery housing 1, 4 is provided with joining elements 1a and the motor housing 6 is provided with joining elements 6a, which are joined such that they cannot move relative to each other by means of joining elements 9 which are by way of example screw elements. The joining elements 1a are straight axial passages which are formed in the housing part 1. The joining elements 6a are axial recesses or passages which are formed in correspondence with the joining elements 1a on the motor housing 6. If the joining elements 9 are embodied as screw elements, as in the example embodiment, the joining elements 6a can be provided with matching internal threads. Advantageously, however, the joining elements 9 intersect the joining elements 6a and thus ensure that the delivery housing 1 is securely held on the motor housing 6.

The layered structure consisting of the end-facing wall 30, the gap filler 32 and the circuit board 33 is immovably joined to the motor housing 6, for example by means of a screw connection or preferably by means of a rivet-like connection which is described further below and can be seen in FIG. 12. Once the layered structure 30, 32, 33 and thus in particular the circuit board 33 has been arranged and fastened, the electronics space is closed off by means of the cover 35. The cover 35 can advantageously be connected to the motor housing 6 in a material bond, for example by means of a friction weld connection.

An assembly structure 37 is provided for assembling the pump, for example in the engine space of a combustion-driven or all-electric or combined combustion/electric motor vehicle. The assembly structure 37 can advantageously be connected to the pump via a damper 36. In the example embodiment, the damper 36 is formed as a damper ring, for example an elastomer ring. The damper 36 is placed around the outer circumference of the motor housing 6 and can then advantageously surround the motor housing 6 with a certain elastic tension. In such embodiments, the damper 36 is adapted to the outer circumference of the motor housing 6 with a certain undersize in relation to an inner circumference. The assembly structure 37 forms a sleeve. It comprises two parts which can be moved relative to each other (in the example embodiment, two half-shell-shaped structural parts) which are applied to the outside of the damper 36 from the side and tightened with a certain tension using suitable fastening means, for example screw means, in order to assemble the motor housing 6 and therefore the pump itself at the point of installation via the damper 36. The assembly structure 37 can comprise one or more joining elements 38 by means of which the assembly structure 37 and therefore the pump can be fastened at the point of installation, for example in an engine space of a motor vehicle.

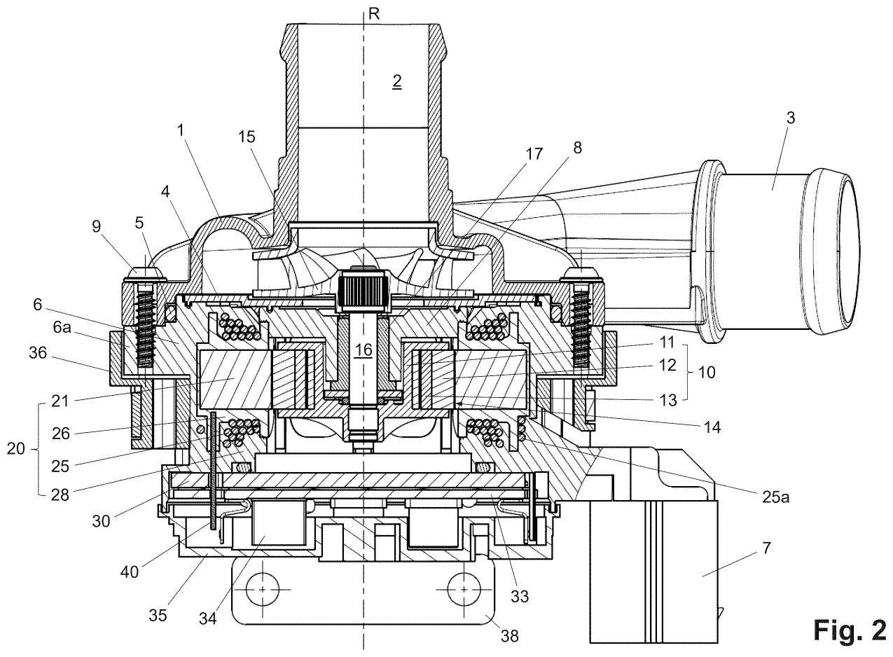

FIG. 2 shows the pump when assembled, in a central longitudinal section in which the rotational axis R of the drive shaft 16 and rotor 10 extends. The spiral-shaped delivery chamber, which connects the central axial inlet 2 to the tangential outlet 3, can be seen. The delivery chamber is closed off on its rear side which faces the drive motor 10, 20 by the rear wall 4. The impeller 15 is arranged, such that it can be rotated about the rotational axis R, in the delivery chamber. When impeller 15 is rotationally driven, the fluid is suctioned via the inlet 2 towards the end-facing side of the impeller 15, deflected radially outwards as is known from radial delivery pumps, and lastly discharged in a tangential direction on the outer circumference of the impeller 15 and expelled via the outlet 3. The rear wall 4 faces axially opposite a rear side of the impeller 15 and forms a gasket, for example a labyrinth gasket, with the impeller 15 in order to separate the delivery chamber from the engine space. The rear wall 4 can form an axial press-fitted assemblage with the delivery housing part 1 and the motor housing 6, i.e. can be axially press-fitted onto the motor housing 6. If the rear wall 4 is a plastic part, it can instead or additionally be fused to the motor housing 6, for example by means of ultrasound welding, laser welding, hot-plate welding, spin welding or vibration welding.

The impeller 15 is non-rotationally connected to the drive shaft 16 and, via the drive shaft 16, to the rotor 10. The rotor 10 and the impeller 15 are arranged coaxially with respect to each other along the drive shaft 16.

The motor housing 6 forms a rotary bearing structure 8 for radially supporting the drive shaft 16 (in the example embodiment, for radially supporting the rotary assemblage consisting of the rotor 10, the impeller 15 and the drive shaft 16). The rotary bearing structure 8 comprises a socket-shaped structural region which surrounds the drive shaft 16 in an axial shaft portion in order to radially support the drive shaft 16 and therefore the rotor 10 and the impeller 15. This axial shaft portion extends between a front shaft portion, in which the drive shaft 16 is non-rotationally connected to the impeller 15, and a rear shaft portion in which the drive shaft 16 is non-rotationally connected to the rotor 10. The bearing arrangement for the drive shaft 16 comprises, in addition to the rotary bearing structure 8, the bearing socket 17 which protrudes into the socket-shaped structural region of the rotary bearing structure 8 and is advantageously connected non-rotationally to the rotary bearing structure 8. The bearing arrangement further comprises the bearing disc 18 (FIG. 1), which serves to axially support the rotor 10, and the gasket 19 (FIG. 1) which extends around the drive shaft 16 and is arranged between a rotor support 11 and the bearing disc 18.

The rotor 10 comprises: the rotor support 11 which is non-rotationally connected to the drive shaft 16 and protrudes radially outwards from the drive shaft 16; a magnet holder 12; and multiple permanent magnets 13 which are arranged on the rotor support 11 in a distribution around the rotational axis R and held in position by the magnet holder 12. The magnet holder 12 can advantageously be formed as a laminated core consisting of rotor laminations which lie axially one on top of the other.

The rotary bearing structure 8 comprises a radially extending connecting support which is for example shaped as an annular disc and which rigidly connects the socket-shaped structural region to the region of the motor housing 6 which extends further outwards radially. The connecting support of the rotary bearing structure 8 protrudes from the radially outer side inwards, towards the drive shaft 16, up to the socket-shaped structural region, and the socket-shaped structural region of the rotary bearing structure 8 protrudes into an annular gap between the drive shaft 16 and the rotor 10. As a result, a space-saving nested arrangement consisting of the drive shaft 16, the rotor 10 and the rotary bearing structure 8 is obtained. In addition, the drive shaft 16 is advantageously radially mounted, axially between the non-rotational connection to the rotor 10 and the non-rotational connection to the impeller 15.

The stator 20 surrounds the rotor 10. The stator 20 comprises: stator teeth 21 featuring electrical coils 25; a primary insulation 26 between the stator teeth 21 and the coils 25; and a secondary insulation 28. The primary insulation 26 and the secondary insulation 28 envelop the coils 25 in a fluidic seal. Current can be passed through the coils 25 via contacting lugs 40 and electrical connector lines 25a connected to said lugs 40. A clearance 14 which is delineated on the radially inner side by the rotor 10 and on the radially outer side by the stator 20 extends in the circumferential direction around the rotational axis R between the rotor 10 and the stator 20.

The drive motor 10, 20 is embodied as a wet rotor. The fluid which can be delivered by the impeller 15 is used to cool the drive motor 10, 20. For this purpose, a small sub-flow of the fluid is diverted from the delivered fluid flow in a higher-pressure fluid region, guided through the engine space in order to cool the drive motor 10, 20 and preferably also the end-facing wall 30 and, via the end-facing wall 30, the circuit board 33 comprising the electronic components 34, and fed back into a lower-pressure fluid region. The diverted sub-flow is driven by a pressure differential which is established between the two fluid regions when the fluid is being delivered. The terms “higher-pressure” and “lower-pressure” are merely intended to express that there is a pressure differential between the fluid regions thus characterised which is sufficient to produce and maintain the sub-flow. The sub-flow is advantageously diverted from a main flow delivered by the impeller 15 and/or fed back into the main flow in the delivery housing 1, 4. The sub-flow can in particular be diverted downstream of the impeller 15 and/or fed back upstream of the impeller 15.

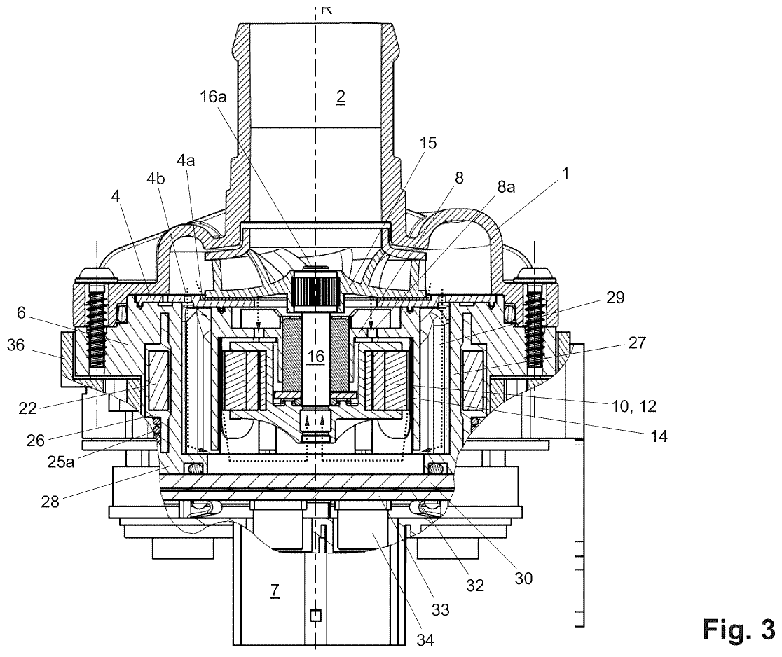

FIG. 3 shows a cooling path along which the sub-flow of the fluid is guided through the engine space. The cooling path extends from a cooling path inlet 4a, which is arranged in the higher-pressure fluid region, into the engine space, where it extends to the clearance 14 and through the clearance 14 to the rear side of the rotor 10, whence it extends through the drive shaft 16 up to a cooling path outlet 16a which emerges in the lower-pressure fluid region. The cooling path inlet 4a is arranged upstream of the cooling path outlet 16a on the path of the main flow delivered by the impeller 15, such that a pressure differential which is sufficient for driving the diverted sub-flow is established. The cooling path inlet 4a leads through a clearance which the impeller 15 forms with the rear wall 4. Leakage fluid passes from the outer circumference of the impeller 15 into the engine space through the cooling path inlet 4a. Downstream of the clearance 14, the fluid comes into contact with the end-facing wall 30 in the engine space and cools the circuit board 33 and, via the circuit board 33, also the electronic components 34 via the end-facing wall 30 and the gap filler 32. The cooling path outlet 15a emerges on the front side of the impeller 15 in the direction of the inlet 2.

The cooling path which extends through the clearance 14 leads through one or more passages 8a of the rotary bearing structure 8. The respective passage 8a extends upstream of the clearance 14 through the connecting support of the rotary bearing structure 8.

The drive shaft 16 is embodied as a hollow shaft. The fluid between the rotor 10 and the end-facing wall 30 in the engine space flows into the drive shaft 16 at a rear end face of the drive shaft 16 and exits into the lower-pressure fluid region at a front end face of the drive shaft 16. In the example embodiment, the drive shaft 16 extends through the impeller 15, and the cooling path outlet 16a is formed on the front end face of the drive shaft 16. In a modification, the impeller 15 can form the cooling path outlet.

The drive motor 10, 20 is not only cooled from the clearance 14. In order to intensify cooling, fluid from the higher-pressure fluid region is additional guided through the stator 20. For this purpose, the stator 20 is provided with internal cooling channels 29 which extend in the axial direction through the stator 20. After it has flowed through the stator 20, this portion of the diverted fluid can be combined in the engine space with the fluid which has flowed through the clearance 14 and can likewise be fed back into the lower-pressure fluid region through the drive shaft 16 at the cooling path outlet 16a.

The combination of a clearance cooling system and an internal stator cooling system ensures more intensive cooling exhibiting increased and requirement-adjusted heat dissipation as compared to either of the two measures individually. This is due to a combination of multiple factors. The cooling volume flow can be increased and more precisely adjusted to requirements. Furthermore, the surfaces of the stator 20 which are involved in heat exchange are larger and can also be selected more precisely in accordance with requirements. In addition, the ratio of the clearance flow to the cooling channel flow can be used to optimise cooling capacity in the sense of more precisely adjusting it to the cooling capacity required.

In the example embodiment, the cooling channels 29 are connected to the higher-pressure fluid region via one or more passages 4b which lead through the rear wall 4. The one or more passages 4b together form an additional cooling path inlet. Fluid for cooling thus reaches the drive motor 10, 20 not only due to unavoidable leakage via the clearance of the impeller 15.

The cooling path of the example embodiment comprises two parallel sub-paths which diverge from each other in the higher-pressure fluid region and converge in the engine space downstream of the clearance 14 and the cooling channels 29 on the one hand and upstream of or at the drive shaft 16 on the other. In modifications, the two cooling paths (one through the clearance 14 and the other through the internal cooling channels 29 of the stator 20) can extend separately from each other from the higher-pressure fluid region up to and into the lower-pressure fluid region. In other modifications, the cooling path which leads through the engine space can also bifurcate into the two sub-paths but not until a point within the engine space. However, the separate additional cooling path inlet enables the pump to be more finely adjusted to the actual cooling requirements, but in a simple design, by supplementing unavoidable leakage fluid, which flows via the cooling path inlet 4a, with additional cooling fluid which flows via the additional cooling path inlet 4b.

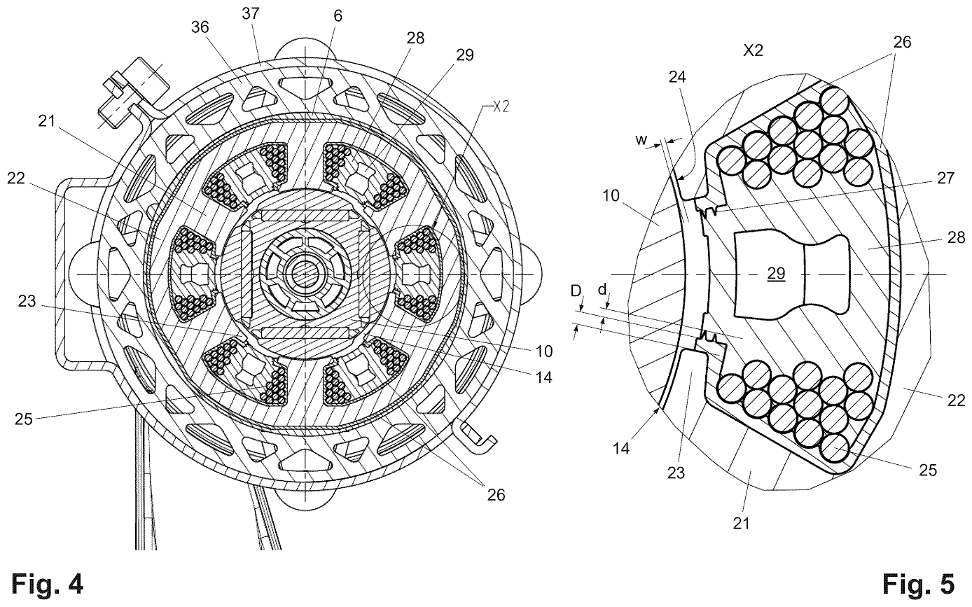

As can be seen in FIGS. 4 and 5 in particular, the stator 20 comprises a stator core having multiple stator teeth 21 which protrude in the radial direction from a stator yoke 22, which extends annularly around the rotational axis R, up to exposed tooth ends 23. Electrical lines are wound around the stator teeth 21 in order to form the electrical coils 25. The stator teeth 21 serve as pole pieces. The stator core 21, 22, 23 can advantageously be formed as a laminated core consisting of stator laminations which are axially layered one on top of the other. The stator laminations can each have the cross-section shown in FIG. 4.

The stator 20 comprises the aforementioned primary insulation 26, which surrounds each of the stator teeth 21 and lines the tooth gaps which remain between the stator teeth 21. The primary insulation 26 is formed between the stator core 21, 22, 23 and the coils 25 and serves to electrically insulate the coils 25. The primary insulation 26 covers the stator core 21, 22, 23 like a skin. It can advantageously envelop the stator core 21, 22, 23 to such an extent that only a circumferential or running surface 24 of the stator core which delineates the clearance 14 remains exposed at the tooth ends 23. Advantageously, the primary insulation 21 is set back slightly from the running surface 24 at the tooth ends 23 but otherwise advantageously envelops the stator core 21, 22, 23 completely, i.e. including on the end-facing sides and the outer circumference. If the stator core 21, 22, 23 is embodied as a laminated core, the primary insulation 26 prevents fluid which penetrates between the stator laminations of the laminated core from being able to come into contact with the coils 25.

The secondary insulation 28 is formed in the tooth gaps of the stator core 21, 22, 23 and serves to electrically separate the coils 25 from the fluid flowing through the clearance 14. The primary insulation 26 and the secondary insulation 28 together envelop the coils 25 and shield them from contact with the fluid. The secondary insulation 28 therefore also surrounds the coils 25 on both end-facing sides. In addition, it also covers the outer circumference of the stator core 21, 22, 23. The secondary insulation 28 advantageously envelops the stator core 21, 22, 23 and the coils 25 completely, except for the running surfaces 24 of the stator teeth 21 which delineate the clearance 14, and in a fluidic seal. Only electrical connector lines 24a lead through the secondary insulation 28, but are enclosed in a fluidic seal by the secondary insulation 28. The running surfaces 24 at the tooth ends 23 of the stator teeth 21 also continue to not comprise the insulating material of the secondary insulation 28. The secondary insulation 28 is advantageously set back slightly from the circumferential surface 24 of the respective stator tooth 21 at the tooth ends 23, but otherwise advantageously envelops the stator core 21, 22, 23 completely.

Since neither the primary insulation 26 nor the secondary insulation 28 covers the running surfaces 24 of the stator teeth 21 which delineate the clearance 14, i.e. the running surface 24 of the respective stator tooth 21 continues to not comprise the insulation 26 and the insulation 28, a width of the clearance 14 which is denoted by “w” in FIG. 5 can advantageously be small. The clearance width w is the clear distance, as measured in the radial direction, between the running surface 24 of the respective stator tooth 21 and the rotor 10. If the clearance width w varies over the circumference because, as for example in the example embodiment, the rotor 10 comprises radially raised circumferential regions, the clearance width w is measured at the radially narrowest point of the clearance 14.

In advantageous embodiments, the circumferential surfaces 24 of the stator core 21, 22, 23 are bare. In principle, however, they can be coated with a protective coating, wherein such a protective coating is applied thinly enough that applying the protective coating does not cause any significant increase in the clearance width w. Such a protective coating, if applied, is in any event thinner than the skin-like primary insulation 26.

The cooling channels 29 extend in the tooth gaps of the stator core 21, 22, 23 in the axial direction through the secondary insulation 28. In particular, one of the cooling channels 29 can respectively extend through the secondary insulation 28 in each of the tooth gaps. The secondary insulation 28 surrounds the respective cooling channel 29 continuously and circumferentially and directly forms the channel wall of the respective cooling channel 29. The cooling channels 29 serve to more intensively cool the coils 25 from the respective tooth gap towards the adjacent stator teeth 21. The coils 25 and the stator core 21, 22, 23 can thus be intensively and effectively cooled, from the clearance 14 on the one hand and from the cooling channels 29 on the other. If the stator core 21, 22, 23 is embodied as a laminated core, fluid from the clearance 14 can penetrate between the stator laminations into the laminated core and up to the primary insulation 26 and ensure an even more effective cooling effect.

The primary insulation 26 and the secondary insulation 28 together prevent fluid from being able to reach the coils 25. In order to shield the coils 25, the primary insulation 26 and the secondary insulation 28 are joined to each other in contact with each other, at least in the region of the tooth ends 23 and continuously and circumferentially around the respective stator tooth 21 in a way which is impermeable to the fluid. In this contact, the secondary insulation 28 can for example exert a certain pressure on the primary insulation 26 in the direction of the stator core 21, 22, 23 and thus ensure the required strength of seal by means of a frictional fit. Instead or additionally, the insulation 26 and the insulation 28 can be joined in a material bond, for example glued and/or fused near their contact surfaces or by means of an adhesive agent. In the region of the tooth ends 23, the insulation 26 and the insulation 28 can comprise joining geometries which continuously encircle the respective stator tooth 21 and interlock and thus improve the strength of seal by way of a positive fit. This joining feature can also be combined with connecting them in a material bond and/or force fit. The insulation 26 and the insulation 28 can be joined to each other in a material bond and/or force fit throughout when in mutual contact. In preferred embodiments, however, the primary insulation 26 and the secondary insulation 28 are joined to each other by a particular joining feature, at least in a particular joining zone which extends annularly around the respective stator tooth 21 between the coils 25 and the clearance 14.

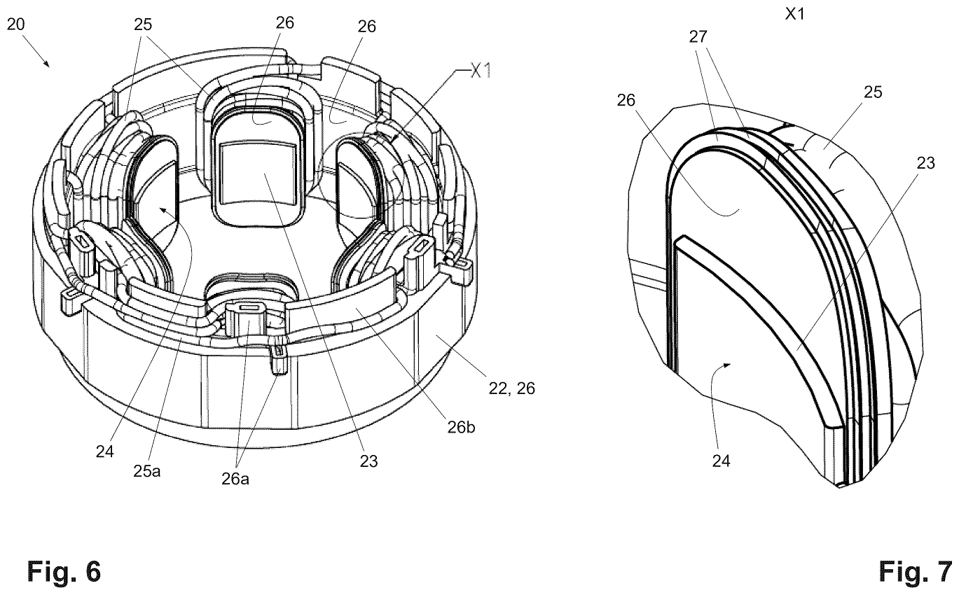

FIG. 6 shows the stator core 21, 22, 23 together with the coils 25 and the primary insulation 26, but before the secondary insulation 28 has yet been produced. FIG. 7 shows an enlarged detail of one of the tooth ends 23 from FIG. 6. The primary insulation 26 envelops the stator core 21, 22, 23 in the manner of a skin all the way up to the vicinity of the tooth ends 23, wherein “up to the vicinity of the tooth ends” means that the primary insulation 26 envelops the stator core 21, 22, 23 beyond the coils 25 in the direction of the tooth ends 23 and that sufficient contact surface is provided between the coils 25 and the tooth ends 23 for the fluidically sealed connection to the secondary insulation 28 which is yet to be produced. At the tooth ends 23, at least the running surface 24 continues to not comprise the primary insulation 26.

In order to more reliably ensure that the coils 25 are shielded, the primary insulation 26 in the joining zone discussed above, which extends annularly around the respective stator tooth 21 between the coils 25 and the clearance 14, comprises a particular joining feature for each stator tooth 21, namely multiple joining geometries 27 which extend annularly around the respective stator tooth 21 next to each other, each in the form of a continuously circumferential rib-like projection which protrudes from the stator tooth 21. The respective joining geometry 27 protrudes by more than half the thickness of the primary insulation 26 from its surface which is otherwise macroscopically smooth.

FIG. 5 indicates the thickness D of the primary insulation 26 and the height(s) d of the joining geometry or geometries 27. Each respective joining geometry 27 expediently exhibits a height d, as measured onto the adjacently smooth surface region, which is greater than 0.2×D or greater than 0.4×D. It is advantageous if the height d is less than 3×D or less than 2×D.

The primary insulation 26 is formed from an electrically insulating plastic. It is advantageous if the plastic is a good thermal conductor. The plastic can be purely a polymer material or advantageously a filled polymer material. The plastic can be a thermoplastic or thermosetting plastic. The primary insulation 26 can in particular be formed in an injection-moulding process. For this purpose, the stator core 21, 22, 23 is placed in an injection mould and the plastic is injection-moulded around it. Once solidified, this plastic forms the primary insulation 26 in the form of a primary injection-moulded insulation. The joining geometries 27 are expediently formed directly in the injection mould during the injection-moulding process.

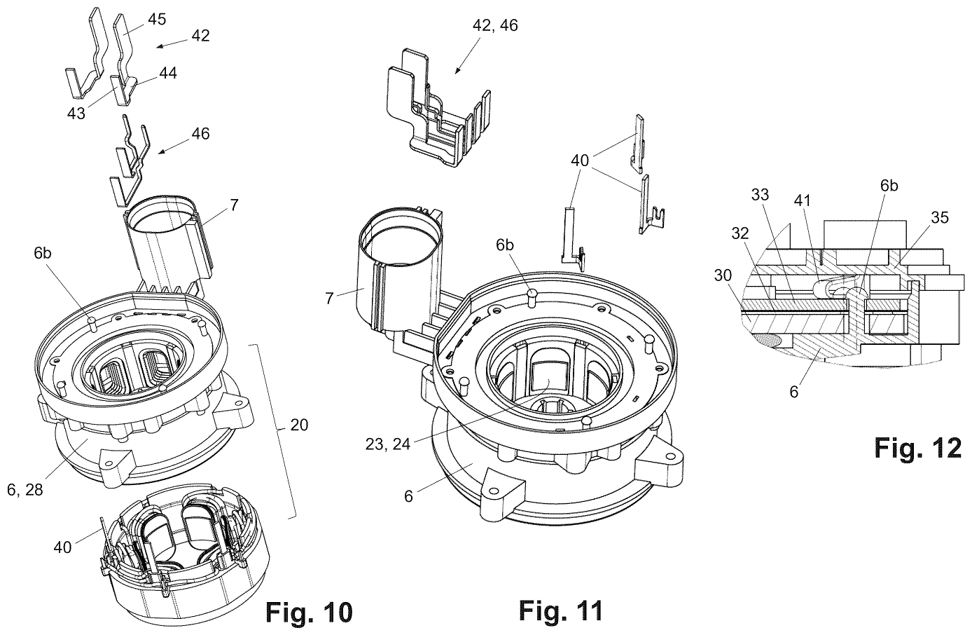

Prior to injection-moulding, contacting lugs 40 (FIGS. 2, 9 and 10) can also be positioned in the injection mould and accordingly fixed in the required position by injection-moulding the plastic of the primary insulation 26 around the contacting lugs 40 together with the stator core 21. The contacting lugs 40 have been removed from view in FIG. 6, which only shows the holding geometries 26a formed by the plastic of the primary insulation 26 which each surround one of the contacting lugs 40 in a holding portion of the respective contacting lug, wherein once the primary insulation 26 has been formed, the respective contacting lug protrudes outwards from its holding geometry 26a for connecting to the motor electronics and remains exposed in an inner portion for connecting to the coils 25. Two of the contacting lugs 40 are shown in FIG. 2. In FIG. 9, they protrude from the secondary insulation 28. FIG. 10 shows the stator core, around which the primary insulation 26 is injection-moulded, together with the fixed contacting lugs 40.

The stator core 21, 22, 23 can be completely enveloped in the plastic of the primary insulation 26 during the injection-moulding process and then exposed again on the circumferential surfaces 24 in an additional method step. More preferably, however, the circumferential surfaces 24 continue to not comprise the plastic of the primary insulation 26 during the injection-moulding process. For this purpose, it is helpful if the primary insulation 26 is set back slightly from the circumferential surfaces 24, i.e. the future running surfaces 24, directly during the injection-moulding process, as can best be seen in the detailed representations in FIGS. 5 and 7. This can counteract the formation of so-called webbing.

In order to produce the coils 25, the stator core 21, 22, 23 which is provided (in the example embodiment, injection-moulded) with the primary insulation 26 is wound with electrical conductor material. Current can be passed through the resultant coils 25 via the contacting lugs 40 (FIGS. 2, 9 and 10) which protrude from the holding geometries 26a on the outer circumference of the stator yoke 22 and are connected to the coils 25 via the electrical connector lines 25a. The coils 25 are connected to the contacting lugs 40 before the secondary insulation 28 is produced. They can for example be connected by means of resistance welding.

A holding geometry 26b for the connector lines 25a can also be formed together with the primary insulation 26 and expediently from the plastic of the primary insulation 26. The holding geometry 26b can be formed such that the connector lines 25a of the coils 25 rest against an outer circumference of the holding geometry 26a and are guided in the circumferential direction along the outer circumference to the respectively associated contacting lug 40. The plastic of the primary insulation can be injection-moulded around the contacting lugs 40, thus fixing them in position, when forming primary insulation 26.

In an additional step for producing the secondary insulation 28, plastic is injection-moulded a second time around the wound stator core 21, 22, 23 which is provided with the contacting lugs 40, in another injection mould, this time with the plastic of the secondary insulation 28, such that the coils 25 are completely and reliably shielded against the ingress of the fluid in the engine space. Following this second injection-moulding process, only the contacting lugs 40 still protrude from the secondary insulation 28.

The secondary insulation 28 is also formed from an electrically insulating plastic. It is advantageous if the plastic of the secondary insulation 28 is a good thermal conductor. The plastic of the secondary insulation 28 can be purely a polymer material or advantageously a filled polymer material. The plastic can be a thermoplastic or thermosetting plastic.

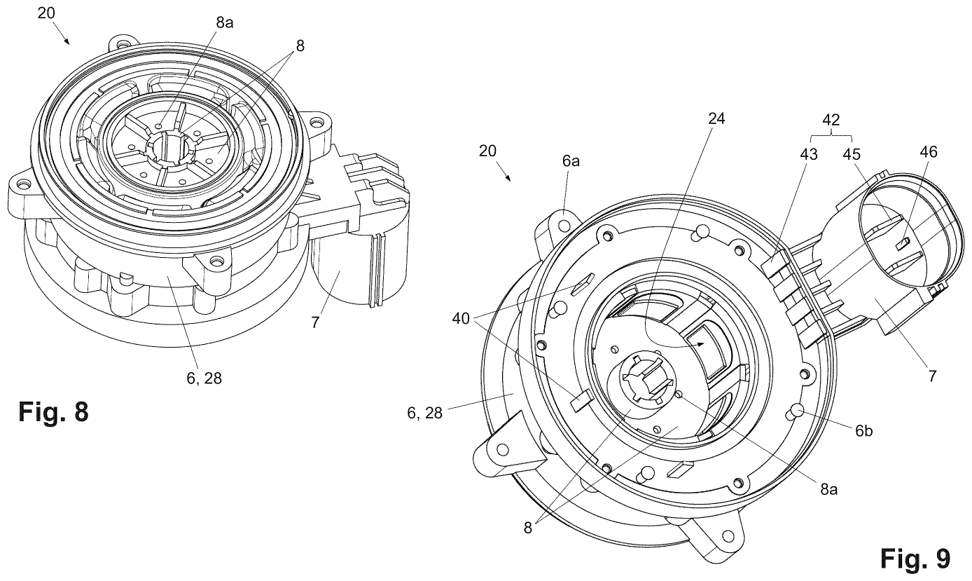

FIGS. 8 and 9 show the stator 20 after the plastic of the secondary insulation 28 has been injection-moulded around it, wherein FIG. 8 is an isometric view onto the front side of the stator 20 which faces the impeller 15 (FIG. 2), and FIG. 9 is an isometric view onto the rear side of the stator 20 which faces away from the impeller 15. In this secondary injection-moulding process, the plastic of the secondary insulation 28 envelops the coils 25 and the stator core 21, 22, 23 on all sides in a fluidic seal, such that only the tooth ends 23 or at least their circumferential or running surface 24 continue to not comprise the secondary insulation 28. In the secondary injection-moulding process, the motor housing 6, the connector housing 7 and the rotary bearing structure 8 are moulded in one piece from the same plastic and at the same time as the secondary insulation 28.

The central socket-shaped structural region of the rotary bearing structure 8 and the connecting support which is shaped as an annular disc and connects the socket-shaped structural region to the outer annular region of the motor housing 6 or the secondary insulation 28, can clearly be seen in FIGS. 8 and 9. It can also clearly be seen that the contacting lugs 40 protrude out of the secondary insulation 28 in the axial direction on the rear side of the stator 20, such that they protrude into the electronics space when the pump is assembled.

The stator 20 also comprises joining elements 6b which protrude in the manner of pins in the axial direction on the rear side of the stator 20. The joining elements 6b are also directly formed from the plastic of the secondary insulation 28 when the plastic of the secondary insulation 28 is injection-moulded around the stator 20. They serve to position and fasten the layered structure consisting of the end-facing wall 30, the gap filler 32 and the circuit board 33 (FIG. 1) relative to and on the stator 20.

On the side of the stator 20 on which the connector housing 7 is formed, electrical connector elements 42 lead from the rear side of the stator 20 or from the electronics space of the pump outwards into the connector housing 7. An inner contact portion 43 and an outer contact portion 45 of each of the connector elements 42 can be seen. The inner contact portions 43 protrude freely in the axial direction from the rear side of the stator, such that they can be electrically connected to corresponding electrical connectors on the circuit board 33. The outer contact portions 45 each protrude freely in the axial direction in the connector housing 7, such that they can be connected to an external power supply and/or controller, for example the motor controller of a motorised vehicle such as in particular a motor vehicle, by establishing a corresponding plugging connection via corresponding connectors.

FIGS. 10 and 11 show in particular the connector elements for electrically connecting the stator 20 to the external power supply and controller, namely the contacting lugs 40 and the connector elements 42 and 46. In FIG. 10, the wound stator core and the secondary insulation 28, which simultaneously also forms the motor housing 6, are shown separately from each other, wherein FIG. 10 shows the wound stator core after the contacting lugs 40 have been connected. The plastic of the secondary insulation 28 is then injection-moulded around the wound stator core, wherein the motor housing 6 comprising the connector housing 7 and the rotary bearing structure 8 is simultaneously formed.

The connector elements 42 and 46 are positioned relative to the wound stator core in the injection mould before the plastic of the secondary insulation 28 is injection-moulded around the stator core, and the plastic of the secondary insulation 28 is also injection-moulded around them, such that after the injection-moulding process, they are embedded in the plastic of the secondary insulation 28 and fixed in position and only the inner contact portion 43 and outer contact portion 45 of each of them protrude freely from the plastic mass. The connector elements 42 and 46 are each U-shaped in a side view, comprising two side limbs, one of which forms the inner contact portion 43 and the other of which forms the outer contact portion 45, and comprising a central connecting portion 44 which connects the two side limbs. Once the secondary insulation 28 and therefore also the motor housing 6 has been formed, the respective connecting limb 44 extends from the respective inner contact portion 43 in the radial direction outwards into the connector housing 7, where it transitions into the outer contact portion 45 which protrudes out of the plastic mass in the connector housing 7.

The connector elements 42 and/or 46 can exhibit a rougher surface in the region of the respective connecting portion 44 than in their contact portions 43 and 45. The surface can for example be fluted or otherwise structured in the respective connecting portion 44, for example by embossing or laser structuring. The greater roughness improves the adhesion to the plastic in which the connecting portion 44 is embedded and improves the seal over the length along which it is embedded.

The detailed representation in FIG. 12 shows the joining connection by means of which the end-facing wall 30, the gap filler 32 and the circuit board 33 are positioned on and fastened to the motor housing 6. When assembled as shown, the joining elements 6b protrude through the layered structure 30, 32, 33 which is provided with corresponding passages for this purpose. The joining elements 6b serve to establish a rivet-like joining connection. When being assembled, the end-facing wall 30, the gap filler 32 and the circuit board 33 are positioned on the rear side of the stator 20 or the motor housing 6, such that the joining elements 6b protrude through the corresponding passages in the layered structure 30, 32, 33 and a head portion of each of them protrudes beyond the circuit board 33. The head portions are then surface-fused or melted such that the joining elements 6b engage behind the circuit board 33 and thus fix it to the motor housing 6.

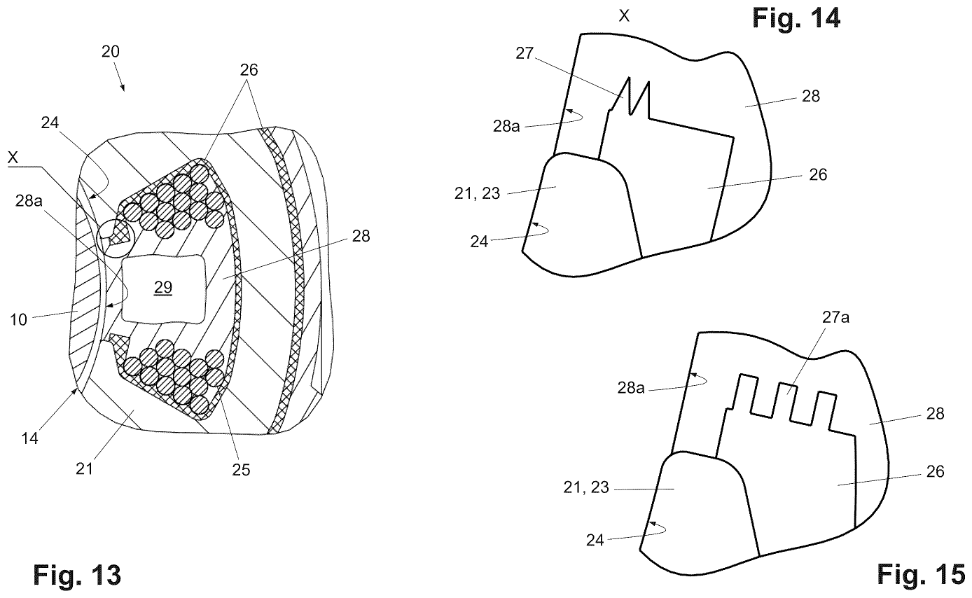

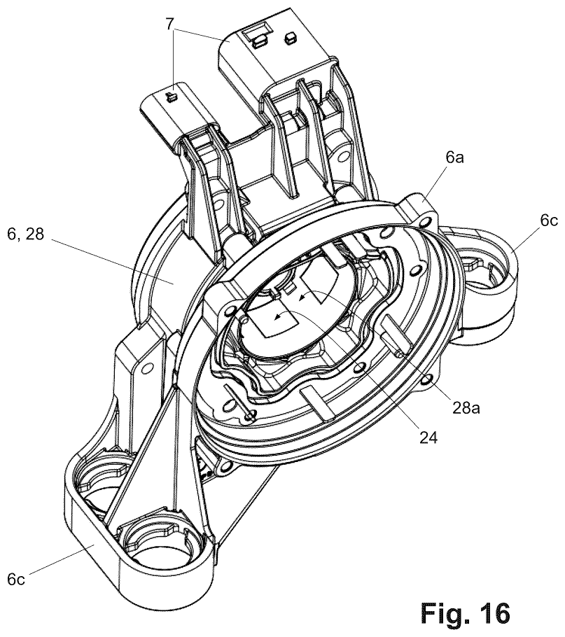

FIG. 13 shows the region of a tooth gap of a modified stator 20 in a cross-section. A first modification is that the stator teeth 21 and the secondary insulation 28 together form a running surface, which is composed of the running surfaces 24 of the stator teeth 21 and running surfaces 28a of the secondary insulation 28 which are alternately consecutive in the circumferential direction, and which is smooth at least substantially throughout in the circumferential direction around the motor axis R. The at least substantially smooth composite running surface 24, 28a reduces or completely avoids turbulence in the fluid in the clearance 14.

FIG. 14 shows a region at a tooth end 23 of the stator teeth 21 and a region of the adjoining tooth gap in an enlarged representation of the detail X indicated in FIG. 13. It can be seen in the enlargement that the running surface 28a formed by the secondary insulation 28 does not adjoin the running surface 24 of the stator teeth 21 exactly flush or smoothly but is instead set back slightly from the running surface 24. The composite running surface 24, 28a thus comprises a flat recess in the region of each of the tooth gaps. In the axial direction, i.e. parallel to the motor axis R, these recesses can be continuous over the length of the secondary insulation 28 or can be delineated on the two end-facing sides of the stator core, i.e. can form pockets. The radial offset between the running surfaces 24 and 28a and the resultant unevenness of the composite running surface 24, 28a are however significantly lower than in the embodiment of the primary insulation 26 and secondary insulation 28 shown in FIGS. 4 and 5.

A second modification is that the secondary insulation 28 extends radially inwards, i.e. towards the motor axis R, beyond the primary insulation 26 and encompasses the latter, i.e. engages behind it as viewed from the base of the tooth gap, and extends in the region of the tooth ends 23 up to the flanks of the stator teeth 21. This geometric modification can improve the seal with respect to the clearance 14. The primary insulation 26 can in principle be extended radially inwards up to the running surface 28a in order to form the running surface 28a together with the secondary insulation 28. It is however advantageous for the secondary insulation 28 alone to form the running surface 28a not only because of the seal with respect to the clearance 14 which the secondary insulation 28 provides by encompassing the primary insulation 26 but also in order to obtain a smooth running surface 28a.

In the example embodiment of FIG. 15, the joining geometry is modified relative to the joining geometry 27 and is therefore referred to as the joining geometry 27a. The modification is that the projections via which the primary insulation 26 protrudes into and/or engages with the secondary insulation 28 exhibit a flat outer circumferential periphery at their outer ends. While the projections of the joining geometry 27 each taper to a point on their outer circumferential periphery, i.e. each form a single point on their outer circumferential periphery in the section shown, the projections of the modified joining geometry 27a each exhibit two edges on their outer circumferential periphery. In the example embodiment,

### REFERENCE SIGNS

1 delivery housing part
1a joining element, passage
2 inlet
3 outlet
4 rear wall
4a cooling path inlet
4b cooling path inlet
5 gasket
6 motor housing
6a joining element, passage
6b joining element
6c assembly geometry
7 connector housing
8 rotary bearing structure
8a passage
9 fastening element
10 rotor
11 rotor support
12 magnet holder
13 permanent magnet
14 clearance
15 impeller
16 drive shaft
16a cooling path outlet
17 bearing socket
18 bearing disc
19 gasket
20 stator
21 stator tooth
22 yoke
23 tooth end
24 inner circumference, running surface
25 coil
25a connector line
26 primary insulation
26b holding geometry
27 joining geometry
27a joining geometry
28 secondary insulation
28a inner circumference, running surface
29 cooling channel
30 end-facing wall
31 gasket
32 gap filler
33 circuit board
34 motor electronics
35 cover
36 damper, elastomer ring
37 assembly structure
38 assembly flange
40 contacting lug
41 connecting line
42 electrical connector element
43 inner contact portion
44 connecting portion
45 outer contact portion
46 electrical connector element
d height of the joining geometry
D thickness of the primary insulation
R rotational axis
w clearance width

1.-20. (canceled)

21. A pump for delivering a fluid, for a cooling fluid and/or a lubricating fluid, the pump comprising:
a delivery housing featuring an inlet and an outlet for the fluid;
an impeller which can be rotated in the delivery housing for delivering the fluid from the inlet to the outlet; and
an electric drive motor comprising a rotor, which can be rotated about a motor axis and is coupled to the impeller in order to drive it, and a stator which together with the rotor forms a clearance around the motor axis, the stator comprising:
a stator core featuring stator teeth, which at least substantially point radially with respect to the motor axis, and tooth gaps which remain between the stator teeth;
electrical lines which are wound around the stator teeth, to form electrical coils;
a primary insulation which is formed between the respective stator tooth and the coil which surrounds the respective stator tooth, in order to electrically insulate it;
and a secondary insulation which is formed in the tooth gaps in order to electrically insulate adjacent coils,
wherein the stator teeth each comprise a running surface at tooth ends which radially faces opposite the rotor across the clearance and does not comprise the primary insulation or the secondary insulation,
and in (each of) one or more of the tooth gaps, a cooling channel through which coolant can flow extends in the axial direction through the secondary insulation.

22. The pump according to claim 21, wherein the primary insulation and the secondary insulation are connected circumferentially around the respective stator tooth in a way which is impermeable to the fluid, at least in the region of the tooth ends, such that the coils are separated from the clearance.

23. The pump according to claim 21, wherein the primary insulation and the secondary insulation comprise one or more joining geometries, in the region of the tooth end of the respective stator tooth, which encircle the respective stator tooth and interlock to form, when engaged, an annular joining zone which is impermeable to the fluid.

24. The pump according to claim 21, wherein the primary insulation and the secondary insulation form, in the region of the tooth ends, a joining zone which extends annularly around the respective stator tooth and in which a microstructure of the primary insulation and a microstructure of the secondary insulation interlock more deeply than at the base of the tooth gaps.

25. The pump according to claim 21, wherein
the primary insulation consists of a first plastic and the secondary insulation consists of a second plastic,
the primary insulation and the secondary insulation are fused in the region of the tooth ends in a joining zone which extends annularly around the respective stator tooth, and
a mixed structure which is formed by the first plastic and the second plastic exhibits a greater depth in the annular joining zone than at the base of the tooth gaps.

26. The pump according to claim 21, wherein the primary insulation envelops the stator core all the way up to the tooth ends, such that only of the tooth ends respectively do not comprise the primary insulation, at least on their running surface which delineate the clearance.

27. The pump according to claim 21, wherein the respective cooling channel is a passage which extends in the axial direction through the secondary insulation.

28. The pump according to claim 21, wherein a cooling path for the fluid extends from a cooling path inlet, which emerges in a higher-pressure region in the delivery housing, through the clearance and/or the respective cooling channel up to a cooling path outlet which emerges in a lower-pressure region in the delivery housing.

29. The pump according to claim 21, wherein the rotor of the drive motor and the impeller are arranged coaxially along a drive shaft which can be rotated about the rotational axis.

30. The pump according to claim 21, wherein the secondary insulation envelops the stator core and the coils all the way up to the tooth ends, such that only the tooth ends of the stator core respectively do not comprise the secondary insulation, at least on their running surface which delineates the clearance.

31. The pump according to claim 21, wherein the secondary insulation is formed in one piece in a primary moulding process together with a motor housing which surrounds the stator core and/or together with an assembly geometry for assembling the pump and/or together with a connector housing for electrically connecting to an external system for supplying power to and/or controlling the drive motor and/or together with a rotary bearing structure for radially bearing a drive shaft which is non-rotationally connected to the rotor and/or the impeller.

32. The pump according to claim 21, wherein the secondary insulation forms a connector housing for one or more electrical connector elements, and the stator can be connected via the connector housing and the respective connector element to an external system for supplying power and/or controlling.

33. The pump according to claim 32, wherein the respective electrical connector element is embedded in the secondary insulation and thus positioned and fixed relative to the motor housing and/or the connector housing.

34. The pump according to claim 21, comprising a rotary bearing structure for rotationally mounting the rotor, wherein the secondary insulation and the rotary bearing structure are formed in one piece by primary moulding.

35. The pump according to claim 21, wherein the clearance exhibits a radial clearance width w which is measured radially with respect to the rotational axis between the running surface of one of the stator teeth and an opposing circumference of the rotor across the clearance, and the primary insulation exhibits a thickness D in the region of the tooth ends, where w<D or w<0.5×D.

36. The pump according to claim 21, wherein
the primary insulation and the secondary insulation are radially set abutting contact from the running surfaces of the stator teeth in the region of the tooth gaps
or instead
the primary insulation and the secondary insulation terminate flush with the running surfaces of the stator teeth in the region of the tooth gaps.

37. The pump according to claim 21, which is embodied as a cooling medium pump for delivering a water/glycol mixture and/or a dielectric heat transfer oil for cooling or tempering (cooling and/or heating)
an internal combustion engine and/or
drivetrain components of a drivetrain for a combustion-driven vehicle and/or
components of the drive train of a battery-driven electric vehicle and/or
the battery cells of a traction battery of a motor vehicle.

38. A method for producing a stator for an electric drive motor, the method comprising:
an electrically insulating first plastic is moulded around a stator core which comprises stator teeth, which at least substantially point radially with respect to a motor axis and exhibit exposed tooth ends, and tooth gaps which remain between the stator teeth, to form a primary insulation which surrounds the stator teeth;
electrical lines are wound around the stator teeth provided with the primary insulation, to form electrical coils;
an electrically insulating second plastic is moulded around the stator core and the coils, to form a secondary insulation which envelops the coils and the stator core beyond the coils and up to the tooth ends; and
when injection-moulding the secondary insulation, cooling channels which extend in the axial direction through the secondary insulation are formed in the region of the tooth gaps in order to channel a fluid which serves to cool the stator,
wherein at the tooth ends, a running surface for forming a clearance with a rotor of the drive motor does not comprise the primary insulation or the secondary insulation.

39. The method according to claim 38, wherein the primary insulation and the secondary insulation are injection-moulded such that the running surface continues to not comprise the first plastic or the second plastic during the injection-moulding process, or wherein plastic adhering to the running surface is ablated following the injection-moulding process.

40. The method according to claim 38, wherein the primary insulation is injection-moulded in the region of the tooth ends with one or more joining geometries in the form of one or more projections and/or recesses which encircle the respective stator tooth, and the respective joining geometry is surface-fused or melted in contact with the second plastic when the secondary insulation is injection-moulded, such that if it is surface-fused, the respective joining geometry engages the secondary insulation or, if it is melted, the respective joining geometry microscopically forms a mixed structure with the first plastic.
